(19) United States
(12) Patent Application Publication
(10) Pub. No.: US 2026/0049023 A1
(43) Pub. Date: Feb. 19, 2026

(54) ULTRA-HIGH COMPRESSIVE STRESS GLASS ARTICLES

(71) Applicant: CORNING INCORPORATED, CORNING, NY (US)

(72) Inventors: Venkatesh Botu, Corning, NY (US); Timothy Michael Gross, Painted Post, NY (US); Bronson David Hausmann, Corning, NY (US); Qiao Li, Horseheads, NY (US); Balamurugan Meenakshi Sundaram, Painted Post, NY (US); Kristy Lynn Smith, Bath, NY (US); Jingshi Wu, Painted Post, NY (US)

(21) Appl. No.: 19/296,040

(22) Filed: Aug. 11, 2025

Related U.S. Application Data
(63) Continuation of application No. PCT/US2025/040291, filed on Aug. 1, 2025.
(60) Provisional application No. 63/683,336, filed on Aug. 15, 2024.

(51) Int. Cl. C03C 3/087; C03C 3/091; C03C 21/00

(52) U.S. Cl. CPC C03C 3/087; C03C 3/091; C03C 21/002

(57) ABSTRACT

A glass composition comprising: 40-60 mol. % SiO₂; 14-30 mol. % Al₂O₃; 1-10 mol. % Li₂O; 15-30 mol. % Na₂O; 1-20 mol. % MgO; 0-10 mol. % CaO; 0-5 mol. % P₂O₅; and a Young's modulus of 82 GPa or less. A glass-based article comprising: a compressive stress layer extending from a surface of the glass-based article to a depth of compression; a potassium layer extending from the surface of the glass-based article to a potassium depth of layer; a central tension region; a thickness; and a glass composition at a center of the glass-based article comprising: 40-60 mol. % SiO₂; 14-30 mol. % Al₂O₃; 1-10 mol. % Li₂O; 15-30 mol. % Na₂O; 1-20 mol. % MgO; 0-10 mol. % CaO; and 0-5 mol. % P₂O₅; wherein a glass having the same composition and microstructure as the glass composition at the center of the glass-based article has a Young's modulus of 82 GPa or less; and optionally wherein the compressive stress layer comprises a maximum compressive stress of 1400-2000 MPa.

### CROSS-REFERENCE TO RELATED APPLICATIONS

This application is a continuation application that claims the benefit of priority to International Application Serial No. PCT/US2025/040291 filed on Aug. 1, 2025, which claims the benefit of priority to U.S. Provisional Application Ser. No. 63/683,336 filed on Aug. 15, 2024, the contents of each of which are relied upon and incorporated herein by reference in their entireties.

### FIELD

The disclosure relates generally to glass compositions that can be made into glass-based substrates having a relatively low Young's modulus, and glass-based articles prepared from such glass-based substrates having a relatively high maximum compressive stress. Such glass-based articles may have a net compressive stress to resist flaw propagation, which articles are suitable for various uses, including as a cover glass for augmented reality headsets.

### BACKGROUND

Glass-based substrates and articles are used in a variety of modern devices, including consumer electronic devices such as smartphones and augmented reality headsets. Such devices may experience stresses when in use, and a glass-based article in a device may break if the bending stresses experienced by the glass-based article are not compensated for in some manner.

Therefore, there is a need in the art for improved glass compositions, glass-based substrates, glass-based articles, and the devices that contain them. This disclosure is directed toward these, as well as other, important goals.

### SUMMARY

The disclosure relates, in various aspects, to a glass composition, comprising:
40-60 mol. % SiO₂;
14-30 mol. % Al₂O₃;
1-10 mol. % Li₂O;
15-30 mol. % Na₂O;
1-20 mol. % MgO;
0-10 mol. % CaO;
0-5 mol. % P₂O₅; and
a Young's modulus of 82 GPa or less.

The disclosure also relates, in various aspects, to a method for ion-exchanging a glass-based substrate, the method comprising:
ion-exchanging the glass-based substrate in a first molten salt bath for a first time period and at a first temperature to form a glass-based article,
wherein the glass-based article comprises:
   a compressive stress layer extending from a surface of the glass-based article to a depth of compression,
   a potassium layer extending from the surface of the glass-based article to a potassium depth of layer; and
   a central tension region, and
the glass-based substrate comprises any glass composition disclosed herein.

Further disclosed herein, in various aspects, is a glass-based article, comprising:
a compressive stress layer extending from a surface of the glass-based article to a depth of compression;
a potassium layer extending from the surface of the glass-based article to a potassium depth of layer;
a central tension region;
a thickness; and
a glass composition at a center of the glass-based article comprising any glass composition disclosed herein, such as a glass composition comprising:
   40-60 mol. % SiO₂;
   14-30 mol. % Al₂O₃;
   1-10 mol. % Li₂O;
   15-30 mol. % Na₂O;
   1-20 mol. % MgO;
   0-10 mol. % CaO; and
   0-5 mol. % P₂O₅;
   wherein a glass having the same composition and microstructure as the glass composition at the center of the glass-based article has a Young's modulus of 82 GPa or less; and
   optionally wherein the compressive stress layer comprises a maximum compressive stress of 1400-2000 MPa.

In some aspects, disclosed herein, in various aspects, is an augmented reality headset, comprising:
electrical components comprising a display; and
any glass-based article disclosed herein disposed over the display.

In some aspects, disclosed herein, in various aspects, is a consumer electronic device, comprising:
a housing having a front surface, a back surface and side surfaces;
electrical components provided at least partially within the housing, the electrical components including at least a controller, a memory, and a display, the display being provided at or adjacent to the front surface of the housing; and
a cover substrate disposed over the display;
wherein at least a portion of at least one of the housing and the cover substrate comprises any glass-based article disclosed herein.

Additional features and advantages of the disclosure will be set forth in the detailed description which follows, and in part will be readily apparent to those skilled in the art from that description or recognized by practicing the aspects as described herein, including the detailed description which follows, the claims, as well as the appended drawings.

It is to be understood that both the foregoing general description and the following detailed description are merely exemplary and are intended to provide an overview or framework for understanding the nature and character of the disclosure and claims. The accompanying drawings are included to provide a further understanding of the disclosure and are incorporated into and constitute a part of this specification. The drawings illustrate various aspects of the disclosure and together with the description serve to explain the principles and operations of the various aspects.

### BRIEF DESCRIPTION OF THE DRAWINGS

The following detailed description can be further understood when read in conjunction with the following drawings. Whenever possible, the same reference numerals will be used throughout the drawings to refer to the same or like parts. It is to be understood that the figures are not drawn to scale and the size of each depicted component or the relative size of one component to another is not intended to be limiting.

FIG. 1 schematically depicts a cross section of a glass-based article having compressive stress regions according to aspects described and disclosed herein.

FIG. 2A is a plan view of an exemplary electronic device incorporating any of the glass-based articles disclosed herein.

FIG. 2B is a perspective view of the exemplary electronic device of FIG. 2A.

FIG. 3 is a graph of stress vs. distance from convex surface calculated for a comparative glass-based article.

FIG. 4 is a graph of stress vs. distance from convex surface calculated for a glass-based article of the disclosure.

FIG. 5 is a plot of Vickers Hardness distribution for a glass-based article of the disclosure and comparative articles.

FIG. 6 is a plot of Knoop Hardness distribution for a glass-based article of the disclosure and comparative articles.

FIG. 7 is a scheme of the set up for Ring-on-Ring (ROR) (Equi-biaxial) flexure.

FIG. 8A is a stress profile for an article of the disclosure and comparative articles, without flare.

FIG. 8B is a stress profile for an article of the disclosure and comparative articles, with flare.

FIG. 9 is a plot of retained strength v. flaw depth for an article of the disclosure and comparative articles, without flare.

FIG. 10 is a plot of retained strength v. flaw depth for an article of the disclosure and comparative articles, with flare.

### DETAILED DESCRIPTION

In the following description, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other.

Where a range of numerical values is recited herein, comprising upper and lower values, unless otherwise stated in specific circumstances, the range is intended to include the endpoints thereof, and all integers and fractions within the range. Further, when an amount, concentration, or other value or parameter is given as a range, one or more ranges, or a list of upper values and lower values, this is to be understood as specifically disclosing all ranges formed from any pair of any upper range limit or value and any lower range limit or value, regardless of whether such pairs are separately disclosed.

The term “substantially” may be utilized herein to represent the inherent degree of uncertainty that may be attributed to any quantitative comparison, value, measurement, or other representation. This term is also utilized herein to represent the degree by which a quantitative representation may vary from a stated reference without resulting in a change in the basic function of the subject matter at issue. Thus, for example, a composition that is “substantially free” of any specific component (e.g., Al₂O₃, MgO, or any other component) is one in which the component is not actively added or batched into the composition, but may be present in small amounts as a contaminant (e.g., less than 1000, 500, 400, 300, 200, or 100 ppm), or, if actively added or batched, is present in an amount less than 1 wt. % (e.g., or can be specified to be less than 0.5 wt. %, 0.1 wt. %, or 0.05 wt. %.), based on total amount of the composition (moles or mass for ppm, and mass for wt. %).

Herein, glass compositions are expressed in terms of mol. % amounts of particular components included therein on an oxide bases unless otherwise indicated (e.g., the amounts may instead be expressed in wt. %). Any component having more than one oxidation state may be present in a glass composition in any oxidation state. However, concentrations of such component are expressed in terms of the oxide in which such component is at its lowest oxidation state unless otherwise indicated.

As utilized herein, a “glass-based substrate” refers to a glass piece that has not been ion exchanged. Similarly, a “glass-based article” refers to a glass piece that has been ion exchanged and is formed by subjecting a glass-based substrate to an ion exchange process. A “glass-based substrate” and a “glass-based article” include substrates and articles, respectively, that are made wholly or partly of glass, such as glass-based substrates that include a surface coating. As used herein, a “glass composition” refers to the components, typically on an oxide basis, of a glass piece, such as a glass-based substrate or glass-based article, and/or “glass composition” can refer to any portion thereof, such as at a center of a glass-based article where ions from ion-exchange typically do not reach.

As used herein, the “frangibility limit” refers to the central tension above which the glass-based article exhibits frangible behavior. “Frangibility” or “frangible behavior” refers to specific fracture behavior when a material is subjected to an impact or mechanical force. As used herein, a glass-based article is considered “non-frangible” when it exhibits no branching in a test area as a result of a frangibility test. As utilized herein, a branch originates at the impact point, and a fragment is considered to be within the test area is any part of the fragment extends into the test area. The fragments, bifurcations, and branches are counted based on any 25 mm by 25 mm square centered on the impact point. Thus, a glass-based article is considered non-frangible if it does not show any branching for any 25 mm by 25 mm square centered on the impact point where the breakage is created according to the procedure described below. A glass-based article is considered “borderline frangible,” “slightly frangible,” or close to the frangibility limit if a glass-based article shows less than or equal to 5 branches for any 25 mm by 25 mm square centered on the impact point. A glass-based article is considered “frangible” if a glass-based article shows more than 5 branches for any 25 mm by 25 mm square centered on the impact point. In a frangibility test, an impact probe is brought in to contact with the multi-phase glass, with the depth to which the impact probe extends into the multi-phase glass increasing in successive contact iterations. The step-wise increase in depth of the impact probe allows the flaw produced by the impact probe to reach the tension region while preventing the application of excessive external force that would prevent the accurate determination of the frangible behavior of the glass-based article. In aspects, the depth of the impact probe in the multi-phase glass may increase by about 5 μm in each iteration, with the impact probe being removed from contact with the glass-based article between each iteration. The test area is any 25 mm by 25 mm square centered at the impact point. While coatings, adhesive layers, and the like may be used in conjunction with the multi-phase glass described herein, such external restraints are not used in determining the frangibility or frangible behavior of the multi-phase glass. In aspects, a film that does not affect the fracture behavior of the multi-phase glass may be applied to the multi-phase glass prior to the frangibility test to prevent the ejection of fragments from the multi-phase glass.

As used herein, the term “liquidus viscosity” refers to the viscosity of a molten glass at the liquidus temperature, and the “liquidus temperature” refers to the temperature at which crystals first appear as a molten glass cools down from the melting temperature, or the temperature at which the very last crystals melt away as temperature is increased from room temperature. Unless specified otherwise, a liquidus viscosity value disclosed in this application is determined by the following method. First, the liquidus temperature of the glass is measured in accordance with ASTM C829-81 (2015), titled “Standard Practice for Measurement of Liquidus Temperature of Glass by the Gradient Furnace Method.” Next, the viscosity of the glass at the liquidus temperature is measured in accordance with ASTM C965-96 (2012), titled “Standard Practice for Measuring Viscosity of Glass Above the Softening Point.” Unless otherwise specified, the liquidus viscosity and temperature of a glass composition or article is measured before the composition or article is subjected to any ion-exchange process or any other strengthening process. In particular, the liquidus viscosity and temperature of a glass composition or article is measured before the composition or article is exposed to an ion-exchange medium, for example before being immersed in an ion-exchange medium such as a molten salt bath.

In some aspects, it is desirable for glass-based substrates herein to have a relatively low Young's modulus. For example, in some aspects, glass-based substrates herein have a Young's modulus of 82 GPa or less (e.g., 81.5 GPa or less, 81 GPa or less, 80.5 GPa or less, 80 GPa or less), or any other Young's modulus disclosed elsewhere herein. Without wishing to be bound by theory, it is believed that when a glass-based substrate has a relatively lower Young's modulus, stress induced by bending will be lower, in accordance with the simple plate bending equation disclosed and discussed elsewhere herein. When paired with ion-exchanging the glass-based substrate to produce a glass-based article having a compressive stress that is greater than a bend-induced stress at characteristic flaw depths, a glass-based article having a net compressive stress at such characteristic flaw depths results. Such a glass-based article with a net compressive stress at characteristic flaw depths (e.g., 5 microns or less) resist propagation of any flaws at such depths, since the compressive stress prevents the propagation of flaws that only penetrate to a depth where a net compressive stress exists.

In this regard, a simple plate bending equation (Eq. 1) shows that the maximum bend induced tensile stress will be lower as the modulus is decreased:

$${σ}_{max} = \frac{Et}{2 R} . \qquad Equation 1$$

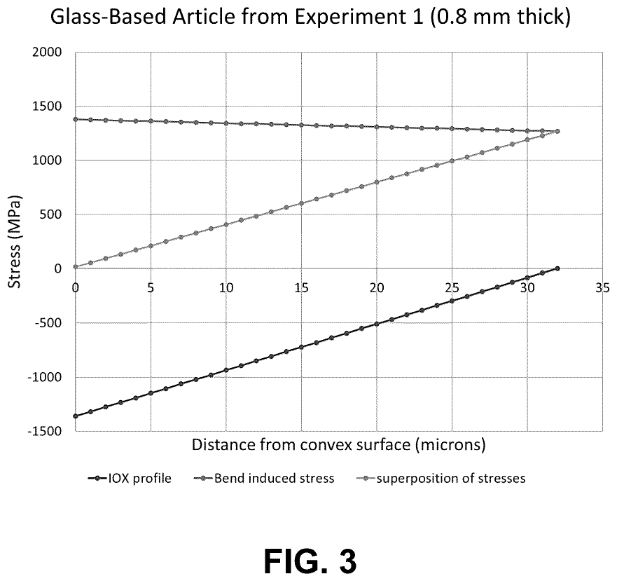

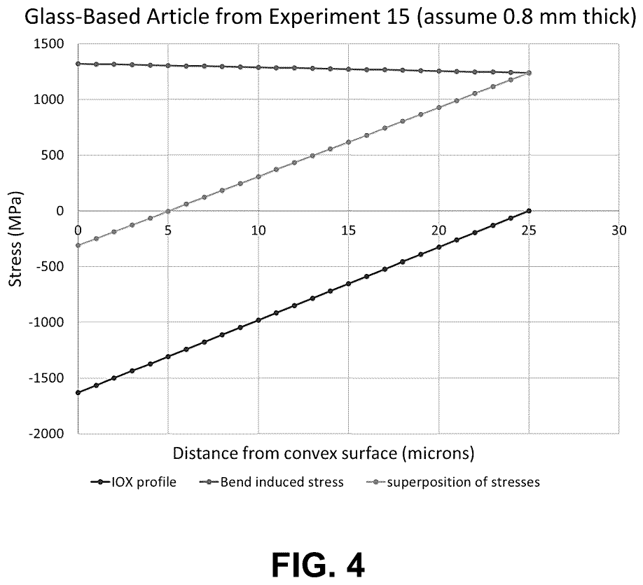

E is Young's modulus, t is substrate thickness, and R is radius of curvature. The stress at any point through the thickness during bending is equal to:

$${σ}_{x} = {σ}_{max} - ( \frac{{σ}_{max}}{\frac{t}{2}} ) * x \qquad Equation 2$$

where x is the depth or normal distance from the convex surface and t is the glass thickness. Ultimately, it is desirable for the ion-exchange compressive stress to be greater than the bend induced stress at a characteristic flaw depth to ensure good reliability. For example, if the characteristic flaw depth is 5 microns, then the superposition of stresses up to an including that depth should result in a net compressive stress (compare, for example, FIG. 3 and FIG. 4).

Currently available glass-based articles have various drawbacks. For example, certain glass-based articles used in certain applications, such as for glasses or goggles, have too low compressive stress and the precursor glass-based substrate too high of a Young's modulus. This particular combination results in a glass-based article that does not have a net compressive stress at characteristic flaw depths. When such glass-based articles are subject to use, some as by bending to a radius of curvature of 20 mm or more, bending stresses result that can cause damage to the glass-based articles. As a result, the disclosure is directed, at least in part, to improved glass compositions that are capable of achieving a higher compressive stress while at the same time employing a precursor glass-based substrate that has a lower Young's modulus. This particular combination, per Equation 1 and Equation 2, results in less bend-induced stress and a net compressive stress. In some aspects, glass compositions are disclosed herein that can be formed into a glass-based article that achieves a maximum compressive stress values about 1400 MPa and a potassium depth of layer of at least 20 microns (e.g., when the article is 0.8 mm thick) (or any other values disclosed herein). In some aspects, glass composition are disclosed herein that have a Young's modulus of 82 GPa or less (or any other values disclosed herein). In some aspects, glass compositions are disclosed herein that have an anneal point of 675° C. or less (or any other value disclosed herein), which facilitates 3D formability. In some aspects, glass compositions are disclosed herein that have relatively fast diffusivity, leading to shorter IOX times, as compared to currently available glasses.

In some aspects, disclosed are glass compositions comprising one or more of SiO₂, Al₂O₃, Li₂O, Na₂O, MgO, CaO, and P₂O₅. In some aspects, disclosed are glass compositions comprising SiO₂, Al₂O₃, Na₂O, and MgO. In some aspects, disclosed are glass compositions comprising SiO₂, Al₂O₃, Li₂O, and MgO. In some aspects, disclosed are glass compositions comprising SiO₂, Al₂O₃, and Na₂O. In some aspects, disclosed are glass compositions comprising SiO₂, Al₂O₃, and Li₂O. In some aspects, disclosed are glass compositions comprising SiO₂, Al₂O₃, Li₂O, Na₂O, and MgO. In some aspects, disclosed are glass compositions comprising SiO₂, Al₂O₃, Li₂O, Na₂O, MgO, and P₂O₅. In some aspects, disclosed are glass compositions comprising SiO₂, Al₂O₃, Li₂O, Na₂O, MgO, and CaO. In some aspects, disclosed are glass compositions comprising SiO₂, Al₂O₃, Na₂O, MgO, and P₂O₅. In some aspects, disclosed are glass compositions comprising SiO₂, Al₂O₃, Li₂O, MgO, and P₂O₅. In some aspects, disclosed are glass compositions comprising SiO₂, Al₂O₃, Na₂O, MgO, and CaO. In some aspects, disclosed are glass compositions comprising SiO₂, Al₂O₃, Li₂O, MgO, and CaO. In some aspects, disclosed are glass compositions comprising SiO₂, Al₂O₃, Li₂O, Na₂O, MgO, CaO, and P₂O₅.

In some aspects, disclosed are glass compositions, comprising: 40-60 mol. % SiO₂; 14-30 mol. % Al₂O₃; 1-10 mol. % Li₂O; 15-30 mol. % Na₂O; 1-20 mol. % MgO; 0-10 mol. % CaO; and 0-5 mol. % P₂O₅.

In some aspects of the glass compositions described herein, SiO₂ is the largest constituent and, as such, SiO₂ is the primary constituent of the glass network formed from the glass composition. Pure SiO₂ has a relatively low coefficient of thermal expansion (CTE). However, pure SiO₂ has a high melting point. Accordingly, if the concentration of SiO₂ in the glass composition is too high, the formability of the glass composition may be diminished as higher concentrations of SiO₂ increase the difficulty of melting the glass, which, in turn, adversely impacts the formability of the glass. Additionally, the inclusion of too much SiO₂ in the glass composition decreases the capacity of the glass to produce compressive stress through ion exchange. If the concentration of SiO₂ in the glass composition is too low the chemical durability of the glass may be diminished, and the glass may be susceptible to surface damage during post-forming treatments. In some aspects, the glass compositions comprise SiO₂ in an amount (mol. %) of at least 40, at least 42, at least 44, at least 46, at least 48, at least 50, at least 52, at least 54, at least 56, at least 58, 60 or less, 58 or less, 56 or less, 54 or less, 52 or less, 50 or less, 48 or less, 46 or less, 44 or less, 42 or less, or any range formed therefrom. For example, in some aspects, the glass compositions comprise SiO₂ in an amount (mol. %) of 40-60, 40-58, 40-56, 40-54, 40-52, 40-50, 40-48, 40-46, 40-44, 40-42, 42-60, 42-58, 42-56, 42-54, 42-52, 42-50, 42-48, 42-46, 42-44, 44-60, 44-58, 44-56, 44-54, 44-52, 44-50, 44-48, 44-46, 46-60, 46-58, 46-56, 46-54, 46-52, 46-50, 46-48, 48-60, 48-58, 48-56, 48-54, 48-52, 48-50, 50-60, 50-58, 50-56, 50-54, 50-52, 52-60, 52-58, 52-56, 52-54, 54-60, 54-58, 54-56, 56-60, 56-58, or 58-60. In particular, in some aspects, the glass compositions comprise SiO₂ in an amount (mol. %) of 50-60, 52-56, 48-54, or 52-60. In some aspects, the glass compositions are free of, or substantially free of, SiO₂.

In some aspects, the glass compositions include Al₂O₃. In some aspects, Al₂O₃ may serve as a glass network former, similar to SiO₂. In some aspects, Al₂O₃ may increase the liquidus viscosity of a glass melt formed from the glass composition due to its tetrahedral coordination, decreasing the formability of the glass composition when the amount of Al₂O₃ is too high. However, when the concentration of Al₂O₃ is balanced against the concentration of SiO₂ and the concentration of alkali oxides in the glass composition, Al₂O₃ can reduce the liquidus temperature of the glass melt, thereby enhancing the liquidus viscosity and improving the compatibility of the glass composition with certain forming processes. An increase in the content of Al₂O₃ relative to the total content of alkali and alkaline earth oxides in the glass composition generally improves the durability of the glass. When the concentration of alkali oxides (R₂O) is close or greater than the amount of Al₂O₃ in the glass composition, predominantly all or all aluminum in the glass is present in tetrahedral coordination state with the alkali ions acting as a charge-compensator. This charge balancing allows for a high diffusivity of alkali ions, increasing the rate of ion exchange. In some aspects, the glass compositions comprise Al₂O₃ in an amount (mol. %) of at least 14, at least 15, at least 16, at least 18, at least 20, at least 22, at least 24, at least 25, at least 26, at least 28, 30 or less, 28 or less, 26 or less, 25 or less, 24 or less, 22 or less, 20 or less, 18 or less, 16 or less, 15 or less, or any range formed therefrom. For example, in some aspects, the glass compositions comprise Al₂O₃ in an amount (mol. %) of 14-30, 14-28, 14-26, 14-25, 14-24, 14-22, 14-20, 14-18, 14-16, 14-15, 15-30, 15-28, 15-26, 15-25, 15-24, 15-22, 15-20, 15-18, 15-16, 16-30, 16-28, 16-26, 16-25, 16-24, 16-22, 16-20, 16-18, 18-30, 18-28, 18-26, 18-25, 18-24, 18-22, 18-20, 20-30, 20-28, 20-26, 20-25, 20-24, 20-22, 22-30, 22-28, 22-26, 22-25, 22-24, 24-30, 24-28, 24-26, 24-25, 25-30, 25-28, 25-26, 26-30, 26-28, or 28-30. In particular, in some aspects, the glass compositions comprise Al₂O₃ in an amount (mol. %) of 15-25, 16-22, 18-20, or 16-24. In some aspects, the glass compositions are free of, or substantially free of, Al₂O₃.

In some aspects, the glass compositions include Li₂O. In some aspects, the inclusion of Li₂O in the glass composition allows for better control of an ion exchange process and further reduces the softening point, liquidus temperature, and melting temperature of the glass, thereby increasing the manufacturability of the glass. The presence of Li₂O in the glass compositions in some aspects also facilitates the formation of a stress profile with a parabolic shape. The inclusion of too much Li₂O in the glass composition increase the coefficient of thermal expansion and lowers the chemical durability of the glass. In some aspects, if insufficient Li₂O is included in the glass composition, the ability of the glass to be ion exchanged is undesirably reduced and the desired stress profile may not be achieved. In some aspects, the glass compositions comprise Li₂O in an amount (mol. %) of 0, >0, at least 1, at least 2, at least 3, at least 4, at least 5, at least 6, at least 7, at least 8, at least 9, 10 or less, 9 or less, 8 or less, 7 or less, 6 or less, 5 or less, 4 or less, 3 or less, 2 or less, 1 or less, or any range formed therefrom. For example, in some aspects, the glass compositions comprise Li₂O in an amount (mol. %) of 0-10, 0-9, 0-8, 0-7, 0-6, 0-5, 0-4, 0-3, 0-2, 0-1, >0-10, >0-9, >0-8, >0-7, >0-6, >0-5, >0-4, >0-3, >0-2, >0-1, 1-10, 1-9, 1-8, 1-7, 1-6, 1-5, 1-4, 1-3, 1-2, 2-10, 2-9, 2-8, 2-7, 2-6, 2-5, 2-4, 2-3, 3-10, 3-9, 3-8, 3-7, 3-6, 3-5, 3-4, 4-10, 4-9, 4-8, 4-7, 4-6, 4-5, 5-10, 5-9, 5-8, 5-7, 5-6, 6-10, 6-9, 6-8, 6-7, 7-10, 7-9, 7-8, 8-10, 8-9, or 9-10. In particular, in some aspects, the glass compositions comprise Li₂O in an amount (mol. %) of >0-5, >0-3, 1-3, 2-5, 2-10, or 1-2. In some aspects, the glass compositions are free of, or substantially free of, Li₂O.

In some aspects, the glass compositions described herein include Na₂O. In some aspects, Na₂O aids in the ion-exchangeability of the glass composition, and improves the formability, and thereby manufacturability, of the glass composition. However, if too much Na₂O is added to the glass composition, the CTE may be too low. Additionally, if too much Na₂O is included in the glass relative to the amount of Li₂O, the ability of the glass to achieve a desired depth of compression when ion exchanged may be reduced. In some aspects, the glass composition comprises Na₂O in an amount (mol. %) of at least 15, at least 16, at least 18, at least 20, at least 22, at least 24, at least 25, at least 26, at least 28, 30 or less, 28 or less, 26 or less, 25 or less, 24 or less, 22 or less, 20 or less, 18 or less, 16 or less, or any range formed therefrom. For example, in some aspects, the glass compositions comprise Na₂O in an amount (mol. %) of 15-30, 15-28, 15-26, 15-25, 15-24, 15-22, 15-20, 15-18, 15-16, 16-30, 16-28, 16-26, 16-25, 16-24, 16-22, 16-20, 16-18, 18-30, 18-28, 18-26, 18-25, 18-24, 18-22, 18-20, 20-30, 20-28, 20-26, 20-25, 20-24, 20-22, 22-30, 22-28, 22-26, 22-25, 22-24, 24-30, 24-28, 24-26, 24-25, 25-30, 25-28, 25-26, 26-30, 26-28, or 28-30. In particular, in some aspects, the glass compositions comprise Na₂O in an amount (mol. %) of 15-25, 16-22, 16-20, or 15-20. In some aspects, the glass compositions are free of, or substantially free of, Na₂O.

In some aspects, the glass compositions described herein include MgO. In some aspects, MgO may lower the liquidus viscosity of a glass and improve the melting behavior, which enhances the formability and manufacturability of the glass. In some aspects, the inclusion of MgO in a glass composition may also improve the strain point and the Young's modulus of the glass composition. However, if too much MgO is added to the glass composition, the liquidus viscosity may be too low for compatibility with desirable forming techniques. The addition of too much MgO may also increase the density and the CTE of the glass composition to undesirable levels and reduce the alkali ion mobility in the glass reducing the effectiveness of ion exchange treatments. In some aspects, the glass compositions comprise MgO in an amount (mol. %) of 0, >0, at least 1, at least 2, at least 4, at least 6, at least 8, at least 10, at least 12, at least 14, at least 16, at least 18, 20 or less, 18 or less, 16 or less, 14 or less, 12 or less, 10 or less, 8 or less, 6 or less, 4 or less, 2 or less, 1 or less, or any range formed therefrom. For example, in some aspects, the glass compositions comprise MgO in an amount (mol. %) of 0-20, 0-18, 0-16, 0-14, 0-12, 0-10, 0-8, 0-6, 0-4, 0-2, 0-1, >0-20, >0-18, >0-16, >0-14, >0-12, >0-10, >0-8, >0-6, >0-4, >0-2, >0-1, 1-20, 1-18, 1-16, 1-14, 1-12, 1-10, 1-8, 1-6, 1-4, 1-2, 2-20, 2-18, 2-16, 2-14, 2-12, 2-10, 2-8, 2-6, 2-4, 4-20, 4-18, 4-16, 4-14, 4-12, 4-10, 4-8, 4-6, 6-20, 6-18, 6-16, 6-14, 6-12, 6-10, 6-8, 8-20, 8-18, 8-16, 8-14, 8-12, 8-10, 10-20, 10-18, 10-16, 10-14, 10-12, 12-20, 12-18, 12-16, 12-14, 14-20, 14-18, 14-16, 16-20, 16-18, or 18-20. In particular, in some aspects, the glass compositions comprise MgO in an amount (mol. %) of 1-10, >0-10, 1-8, or >0-8. In some aspects, the glass compositions are free of, or substantially free of, MgO.

In some aspects, the glass compositions described herein may include CaO. In some aspects, CaO may lower the liquidus viscosity of a glass, which may enhance the formability, the strain point, and the Young's modulus. However, if too much CaO is added to the glass composition, the density and the CTE of the glass composition may increase to undesirable levels and the ion exchangeability of the glass may be undesirably impeded due to decreased alkali ion mobility. In some aspects, the glass compositions comprise CaO in an amount (mol. %) of 0, >0, at least 1, at least 2, at least 3, at least 4, at least 5, at least 6, at least 7, at least 8, at least 9, 10 or less, 9 or less, 8 or less, 7 or less, 6 or less, 5 or less, 4 or less, 3 or less, 2 or less, 1 or less, or any range formed therefrom. For example, in some aspects, the glass compositions comprise CaO in an amount (mol. %) of 0-10, 0-9, 0-8, 0-7, 0-6, 0-5, 0-4, 0-3, 0-2, 0-1, >0-10, >0-9, >0-8, >0-7, >0-6, >0-5, >0-4, >0-3, >0-2, >0-1, 1-10, 1-9, 1-8, 1-7, 1-6, 1-5, 1-4, 1-3, 1-2, 2-10, 2-9, 2-8, 2-7, 2-6, 2-5, 2-4, 2-3, 3-10, 3-9, 3-8, 3-7, 3-6, 3-5, 3-4, 4-10, 4-9, 4-8, 4-7, 4-6, 4-5, 5-10, 5-9, 5-8, 5-7, 5-6, 6-10, 6-9, 6-8, 6-7, 7-10, 7-9, 7-8, 8-10, 8-9, or 9-10. In particular, in some aspects, the glass compositions comprise CaO in an amount (mol. %) of 0-5, >0-5, >0-3, 1-3, 2-5, or >0-4. In some aspects, the glass compositions are free of, or substantially free of, CaO.

In some aspects, the glass compositions described herein may include P₂O₅. In some aspects, adding P₂O₅ increases ion-exchange diffusivity and raised the liquidus viscosity and zircon breakdown temperature. However, it was empirically found that addition of P₂O₅ into glass compositions containing MgO, CaO and ZnO, such as in the present disclosure, may sometimes cause undesirable phase separation. Therefore, limiting the amount of P₂O₅, such as to amounts below 5 mol. % (or any of the other ranges disclosed herein form P₂O₅) is desired. In some aspects, the glass compositions comprise P₂O₅ in an amount (mol. %) of 0, >0, at least 0.5, at least 1, at least 1.5, at least 2, at least 2.5, at least 3, at least 3.5, at least 4, at least 4.5, 5 or less, 4.5 or less, 4 or less, 3.5 or less, 3 or less, 2.5 or less, 2 or less, 1.5 or less, 1 or less, 0.5 or less, or any range formed therefrom. For example, in some aspects, the glass compositions comprise P₂O₅ in an amount (mol. %) of 0-5, 0-4.5, 0-4, 0-3.5, 0-3, 0-2.5, 0-2, 0-1.5, 0-1, 0-0.5, >0-5, >0-4.5, >0-4, >0-3.5, >0-3, >0-2.5, >0-2, >0-1.5, >0-1, >0-0.5, 0.5-5, 0.5-4.5, 0.5-4, 0.5-3.5, 0.5-3, 0.5-2.5, 0.5-2, 0.5-1.5, 0.5-1, 1-5, 1-4.5, 1-4, 1-3.5, 1-3, 1-2.5, 1-2, 1-1.5, 1.5-5, 1.5-4.5, 1.5-4, 1.5-3.5, 1.5-3, 1.5-2.5, 1.5-2, 2-5, 2-4.5, 2-4, 2-3.5, 2-3, 2-2.5, 2.5-5, 2.5-4.5, 2.5-4, 2.5-3.5, 2.5-3, 3-5, 3-4.5, 3-4, 3-3.5, 3.5-5, 3.5-4.5, 3.5-4, 4-5, 4-4.5, or 4.5-5. In particular, in some aspects, the glass compositions comprise P₂O₅ in an amount of 0-5, 0-1, 0.5-4.5, 5 or less, 4.5 or less, or 4 or less. In some aspects, the glass compositions are free of, or substantially free of, P₂O₅.

In some aspects, the glass compositions described herein may include TiO₂. In some aspects, inclusion of TiO₂ provides UV-blocking properties to the glass compositions. In some aspects, the glass compositions comprise TiO₂ in an amount (mol. %) of 0, >0, at least 0.05, at least 0.1, at least 0.15, at least 0.2, at least 0.25, at least 0.3, at least 0.35, at least 0.4, at least 0.45, at least 0.5, at least 0.6, at least 0.7, at least 0.8, at least 0.9, 1 or less, 0.9 or less, 0.8 or less, 0.7 or less, 0.6 or less, 0.5 or less, 0.45 or less, 0.4 or less, 0.35 or less, 0.3 or less, 0.25 or less, 0.2 or less, 0.15 or less, 0.1 or less, 0.05 or less, or any range formed therefrom. For example, in some aspects, the glass compositions comprise TiO₂ in an amount (mol. %) of 0-1, 0-0.9, 0-0.8, 0-0.7, 0-0.6, 0-0.5, 0-0.45, 0-0.4, 0-0.35, 0-0.3, 0-0.25, 0-0.2, 0-0.15, 0-0.1, 0-0.05, >0-1, >0-0.9, >0-0.8, >0-0.7, >0-0.6, >0-0.5, >0-0.45, >0-0.4, >0-0.35, >0-0.3, >0-0.25, >0-0.2, >0-0.15, >0-0.1, >0-0.05, 0.05-1, 0.05-0.9, 0.05-0.8, 0.05-0.7, 0.05-0.6, 0.05-0.5, 0.05-0.45, 0.05-0.4, 0.05-0.35, 0.05-0.3, 0.05-0.25, 0.05-0.2, 0.05-0.15, 0.05-0.1, 0.1-1, 0.1-0.9, 0.1-0.8, 0.1-0.7, 0.1-0.6, 0.1-0.5, 0.1-0.45, 0.1-0.4, 0.1-0.35, 0.1-0.3, 0.1-0.25, 0.1-0.2, 0.1-0.15, 0.15-1, 0.15-0.9, 0.15-0.8, 0.15-0.7, 0.15-0.6, 0.15-0.5, 0.15-0.45, 0.15-0.4, 0.15-0.35, 0.15-0.3, 0.15-0.25, 0.15-0.2, 0.2-1, 0.2-0.9, 0.2-0.8, 0.2-0.7, 0.2-0.6, 0.2-0.5, 0.2-0.4, 0.2-0.3, 0.2-0.25, 0.25-1, 0.25-0.9, 0.25-0.8, 0.25-0.7, 0.25-0.6, 0.25-0.5, 0.25-0.45, 0.25-0.35, 0.25-0.3, 0.3-1, 0.3-0.9, 0.3-0.8, 0.3-0.7, 0.3-0.6, 0.3-0.5, 0.3-0.4, 0.3-0.35, 0.35-1, 0.35-0.9, 0.35-0.8, 0.35-0.7, 0.35-0.6, 0.35-0.5, 0.35-0.4, 0.4-1, 0.4-0.9, 0.4-0.8, 0.4-0.7, 0.4-0.6, 0.4-0.5, 0.5-1, 0.5-0.9, 0.5-0.8, 0.5-0.7, 0.5-0.6, 0.6-1, 0.6-0.9, 0.6-0.8, 0.6-0.7, 0.7-1, 0.7-0.9, 0.7-0.8, 0.7-1, 0.7-0.9, 0.7-0.8, 0.8-1, 0.8-0.9, or 0.9-1. In particular, in some aspects, the glass compositions comprise TiO₂ in an amount of 0-0.5, >0-0.2, 0-0.3, or >0-0.15. In some aspects, the glass compositions are free of, or substantially free of, TiO₂.

In some aspects, the glass compositions comprise a ratio of R₂O/Al₂O₃ of any suitable value, in which the R₂O and Al₂O₃ amounts are in mol. %, and R₂O is a total amount of Li₂O, Na₂O, K₂O, Rb₂O, and Cs₂O in the glass composition. In some aspects, glass compositions comprise a ratio of R₂O/Al₂O₃ of at least 0.9, at least 0.95, at least 1, at least 1.05, at least 1.1, at least 1.15, at least 1.2, at least 1.25, at least 1.3, at least 1.35, at least 1.4, at least 1.45, at least 1.5, at least 1.55, 1.6 or less, 1.55 or less, 1.5 or less, 1.45 or less, 1.4 or less, 1.35 or less, 1.3 or less, 1.25 or less, 1.2 or less, 1.15 or less, 1.1 or less, 1.05 or less, 1 or less, 0.95 or less, or any range formed therefrom. For example, in some aspects, the glass compositions comprise a ratio of R₂O/Al₂O₃ (mol. %/mol. %) of 0.9-1.6, 0.9-1.55, 0.9-1.5, 0.9-1.45, 0.9-1.4, 0.9-1.35, 0.9-1.3, 0.9-1.25, 0.9-1.2, 0.9-1.15, 0.9-1.1, 0.9-1.05, 0.9-1, 0.9-0.95, 0.95-1.6, 0.95-1.55, 0.95-1.5, 0.95-1.45, 0.95-1.4, 0.95-1.35, 0.95-1.3, 0.95-1.25, 0.95-1.2, 0.95-1.15, 0.95-1.1, 0.95-1.05, 0.95-1, 1-1.6, 1-1.55, 1-1.5, 1-1.45, 1-1.4, 1-1.35, 1-1.3, 1-1.25, 1-1.2, 1-1.15, 1-1.1, 1-1.05, 1.05-1.6, 1.05-1.55, 1.05-1.5, 1.05-1.45, 1.05-1.4, 1.05-1.35, 1.05-1.3, 1.05-1.25, 1.05-1.2, 1.05-1.15, 1.05-1.1, 1.1-1.6, 1.1-1.55, 1.1-1.5, 1.1-1.45, 1.1-1.4, 1.1-1.35, 1.1-1.3, 1.1-1.25, 1.1-1.2, 1.1-1.15, 1.15-1.6, 1.15-1.55, 1.15-1.5, 1.15-1.45, 1.15-1.4, 1.15-1.35, 1.15-1.3, 1.15-1.25, 1.15-1.2, 1.2-1.6, 1.2-1.55, 1.2-1.5, 1.2-1.45, 1.2-1.4, 1.2-1.35, 1.2-1.3, 1.2-1.25, 1.25-1.6, 1.25-1.55, 1.25-1.5, 1.25-1.45, 1.25-1.4, 1.25-1.35, 1.25-1.3, 1.3-1.6, 1.3-1.55, 1.3-1.5, 1.3-1.45, 1.3-1.4, 1.3-1.35, 1.35-1.6, 1.35-1.55, 1.35-1.5, 1.35-1.45, 1.35-1.4, 1.4-1.6, 1.4-1.55, 1.4-1.5, 1.4-1.45, 1.45-1.6, 1.45-1.55, 1.45-1.5, 1.5-1.6, 1.5-1.55, or 1.55-1.6. In particular, in some aspects, the glass compositions comprise a ratio of R₂O/Al₂O₃ (mol. %/mol. %) of 1-1.3, 0.95-1.25, 1-1.15, or 0.9-1.2.

In some aspects, the glass compositions comprise R₂O in any suitable amount, in which R₂O is a total amount of Li₂O, Na₂O, K₂O, Rb₂O, and Cs₂O in the glass composition. In some aspects, glass compositions comprise R₂O (mol. %) in an amount of at least 19, at least 20, at least 21, at least 22, at least 23, at least 24, at least 25, at least 26, at least 27, at least 28, at least 29, 30 or less, 29 or less, 28 or less, 27 or less, 26 or less, 25 or less, 24 or less, 23 or less, 22 or less, 21 or less, 20 or less, or any range formed therefrom. For example, in some aspects, the glass compositions comprise R₂O in an amount (mol %) of 19-30, 19-29, 19-28, 19-27, 19-26, 19-25, 19-24, 19-23, 19-22, 19-21, 19-20, 20-30, 20-29, 20-28, 20-27, 20-26, 20-25, 20-24, 20-23, 20-22, 20-21, 21-30, 21-29, 21-28, 21-27, 21-26, 21-25, 21-24, 21-23, 21-22, 22-30, 22-29, 22-28, 22-27, 22-26, 22-25, 22-24, 22-23, 23-30, 23-29, 23-28, 23-27, 23-26, 23-25, 23-24, 24-30, 24-29, 24-28, 24-27, 24-26, 24-25, 25-30, 25-29, 25-28, 25-27, 25-26, 26-30, 26-29, 26-28, 26-27, 27-30, 27-29, 27-28, 28-30, 28-29, or 29-30. In particular, in some aspects, the glass compositions comprise R₂O in an amount (mol. %) of 19-22, 19-25, or 20-24. In some aspects, the glass compositions are free of, or substantially free of, R₂O.

In some aspects, the glass compositions comprise Al₂O₃+MgO (i.e., the sum of Al₂O₃+MgO) in any suitable amount. In some aspects, the glass compositions comprise Al₂O₃+MgO in an amount (mol. %) of at least 19, at least 20, at least 21, at least 22, at least 23, at least 24, at least 25, at least 26, at least 27, at least 28, at least 29, at least 30, 31 or less, 30 or less, 29 or less, 28 or less, 27 or less, 26 or less, 25 or less, 24 or less, 23 or less, 22 or less, 21 or less, 20 or less, or any range formed therefrom. For example, in some aspects, the glass compositions comprise Al₂O₃+MgO in an amount (mol. %) of 19-31, 19-30, 19-29, 19-28, 19-27, 19-26, 19-25, 19-24, 19-23, 19-22, 19-21, 19-20, 20-31, 20-30, 20-29, 20-28, 20-27, 20-26, 20-25, 20-24, 20-23, 20-22, 20-21, 21-31, 21-30, 21-29, 21-28, 21-27, 21-26, 21-25, 21-24, 21-23, 21-22, 22-31, 22-30, 22-29, 22-28, 22-27, 22-26, 22-25, 22-24, 22-23, 23-31, 23-30, 23-29, 23-28, 23-27, 23-26, 23-25, 23-24, 24-31, 24-30, 24-29, 24-28, 24-27, 24-26, 24-25, 25-31, 25-30, 25-29, 25-28, 25-27, 25-26, 26-31, 26-30, 26-29, 26-28, 26-27, 27-31, 27-30, 27-29, 27-28, 28-31, 28-29, 29-31, 29-30, or 30-31. In particular, in some aspects, the glass compositions comprise Al₂O₃+MgO in an amount (mol. %) of 19-27, 19-26, or 20-26. In some aspects, the glass compositions are free of, or substantially free of, Al₂O₃+MgO.

In some aspects, the glass compositions may include one or more fining agents. In some aspects, the fining agent may include, for example, SnO₂. In some aspects, SnO₂ may be present in the glass compositions in an amount (mol. %) of 0, >0, at least 0.01, at least 0.05, at least 0.1, at least 0.15, at least 0.2, at least 0.25, at least 0.3, at least 0.4, at least 0.6, at least 0.8, 1 or less, 0.8 or less, 0.6 or less, 0.4 or less, 0.3 or less, 0.25 or less, 0.2 or less, 0.15 or less, 0.1 or less, 0.05 or less, 0.01 or less, or any range formed therefrom. For example, in some aspects, the glass compositions can comprise SnO₂ in an amount (mol. %) of 0-1, 0-0.8, 0-0.6, 0-0.4, 0-0.3, 0-0.2, 0-0.1, 0-0.05, >0-1, >0-0.8, >0-0.6, >0-0.4, >0-0.3, >0-0.2, >0-0.1, >0-0.05, 0.05-1, 0.05-0.8, 0.05-0.6, 0.05-0.4, 0.05-0.3, 0.05-0.2, 0.05-0.1, 0.1-1, 0.1-0.8, 0.1-0.6, 0.1-0.4, 0.1-0.3, 0.1-0.25, 0.1-0.2, 0.1-0.15, 0.15-1, 0.15-0.8, 0.15-0.6, 0.15-0.4, 0.15-0.3, 0.15-0.25, 0.15-0.2, 0.2-1, 0.2-0.8, 0.2-0.6, 0.2-0.4, 0.2-0.3, 0.2-0.25, 0.25-1, 0.25-0.8, 0.25-0.6, 0.25-0.4, 0.25-0.3, 0.3-1, 0.3-0.8, 0.3-0.6, 0.3-0.4, 0.4-1, 0.4-0.8, 0.4-0.6, 0.6-1, 0.6-0.8, or 0.8-1. In particular, in some aspects, the glass compositions comprise SnO₂ in an amount (mol. %) of >0-0.3, 0.05-0.2, or >0-0.15. In some aspects, the glass composition may be free, or substantially free, of SnO₂.

In some aspects, the glass compositions may include B₂O₃. In some aspects, the glass compositions comprise B₂O₃ in an amount (mol. %) of 0, >0, at least 0.1, at least 0.2, at least 0.4, at least 0.5, at least 0.6, at least 0.8, at least 1, at least 1.5, at least 2, at least 2.5, at least 3, at least 3.5, at least 4, at least 4.5, 5 or less, 4.5 or less, 4 or less, 3.5 or less, 3 or less, 2.5 or less, 2 or less, 1.5 or less, 1 or less, 0.8 or less, 0.6 or less, 0.5 or less, 0.4 or less, 0.2 or less, 0.1 or less, or any range formed therefrom. For example, in some aspects, the glass compositions comprise B₂O₃ in an amount (mol. %) of 0-5, 0-4.5, 0-4, 0-3.5, 0-3, 0-22.5, 0-2, 0-1.5, 0-1, 0-0.8, 0-0.6, 0-0.5, 0-0.4, 0-0.2, 0-0.1, >0-5, >0-4.5, >0-4, >0-3.5, >0-3, >0-2.5, >0-2, >0-1.5, >0-1, >0-0.8, >0-0.6, >0-0.5, >0-0.4, >0-0.2, >0-0.1, 0.1-5, 0.1-4.5, 0.1-4, 0.1-3.5, 0.1-3, 0.1-2.5, 0.1-2, 0.1-1.5, 0.1-1, 0.1-0.8, 0.1-0.6, 0.1-0.5, 0.1-0.4, 0.1-0.2, 0.2-5, 0.2-4.5, 0.2-4, 0.2-3.5, 0.2-3, 0.2-2.5, 0.2-2, 0.2-1.5, 0.2-1, 0.2-0.8, 0.2-0.6, 0.2-0.5, 0.2-0.4, 0.4-5, 0.4-4.5, 0.4-4, 0.4-3.5, 0.4-3, 0.4-2.5, 0.4-2, 0.4-1.5, 0.4-1, 0.4-0.8, 0.4-0.6, 0.4-0.5, 0.5-5, 0.5-4.5, 0.5-4, 0.5-3.5, 0.5-3, 0.5-2.5, 0.5-2, 0.5-1.5, 0.5-1, 0.5-0.8, 0.5-0.6, 0.6-5, 0.6-4.5, 0.6-4, 0.6-3.5, 0.6-3, 0.6-2.5, 0.6-2, 0.6-1.5, 0.6-1, 0.6-0.8, 0.8-5, 0.8-4.5, 0.8-4, 0.8-3.5, 0.8-3, 0.8-2.5, 0.8-2, 0.8-1.5, 0.8-1, 1-5, 1-4.5, 1-4, 1-3.5, 1-3, 1-2.5, 1-2, 1-1.5, 1.5-5, 1.5-4.5, 1.5-4, 1.5-3.5, 1.5-3, 1.5-2.5, 1.5-2, 2-5, 2-4.5, 2-4, 2-3.5, 2-3, 2-2.5, 2.5-5, 2.5-4.5, 2.5-4, 2.5-3.5, 2.5-3, 3-5, 3-4.5, 3-4, 3-3.5, 3.5-5, 3.5-4.5, 3.5-4, 4-5, 4-4.5, or 4.5-5. In particular, in some aspects, the glass compositions comprise B₂O₃ in an amount (mol. %) of 0-2, >0-1, 0-0.5, or 0.1-0.6. In some aspects, the glass compositions are free of, or substantially free of, B₂O₃.

In some aspects, the glass compositions may include K₂O. In some aspects, the glass compositions comprise K₂O in an amount (mol. %) of 0, >0, at least 0.1, at least 0.2, at least 0.3, at least 0.4, at least 0.5, at least 0.6, at least 0.8, at least 1, at least 1.2, at least 1.4, at least 1.6, at least 1.8, 2 or less, 1.8 or less, 1.6 or less, 1.4 or less, 1.2 or less, 1 or less, 0.8 or less, 0.6 or less, 0.5 or less, 0.4 or less, 0.3 or less, 0.2 or less, 0.1 or less, or any range formed therefrom. For example, in some aspects, the glass compositions comprise K₂O in an amount (mol. %) of 0-2, 0-1.8, 0-1.6, 0-1.4, 0-1.2, 0-1, 0-0.8, 0-0.6, 0-0.5, 0-0.4, 0-0.3, 0-0.2, 0-0.1, >0-2, >0-1.8, >0-1.6, >0-1.4, >0-1.2, >0-1, >0-0.8, >0-0.6, >0-0.5, >0-0.4, >0-0.3, >0-0.2, >0-0.1, 0.1-2, 0.1-1.8, 0.1-1.6, 0.1-1.4, 0.1-1.2, 0.1-1, 0.1-0.8, 0.1-0.6, 0.1-0.4, 0.1-0.2, 0.2-2, 0.2-1.8, 0.2-1.6, 0.2-1.4, 0.2-1.2, 0.2-1, 0.2-0.8, 0.2-0.6, 0.2-0.5, 0.2-0.4, 0.2-0.3, 0.3-2, 0.3-1.8, 0.3-1.6, 0.3-1.4, 0.3-1.2, 0.3-1, 0.3-0.8, 0.3-0.6, 0.3-0.5, 0.3-0.4, 0.4-2, 0.4-1.8, 0.4-1.6, 0.4-1.4, 0.4-1.2, 0.4-1, 0.4-0.8, 0.4-0.6, 0.4-0.5, 0.5-2, 0.5-1.8, 0.5-1.6, 0.5-1.4, 0.5-1.2, 0.5-1, 0.5-0.8, 0.5-0.6, 0.6-2, 0.6-1.8, 0.6-1.6, 0.6-1.4, 0.6-1.2, 0.6-1, 0.6-0.8, 0.8-2, 0.8-1.8, 0.8-1.6, 0.8-1.4, 0.8-1.2, 0.8-1, 1-2, 1-1.8, 1-1.6, 1-1.4, 1-1.2, 1.2-2, 1.2-1.8, 1.2-1.6, 1.2-1.4, 1.4-2, 1.4-1.8, 1.4-1.6, 1.6-2, 1.6-1.8, or 1.8-2. In particular, in some aspects, the glass compositions comprise K₂O in an amount (mol. %) of 0-0.6, >0-0.6, 0.1-0.4, or 0-0.5. In some aspects, the glass compositions are free of, or substantially free of, K₂O.

In some aspects, the glass compositions may include SrO. In some aspects, the glass compositions comprise SrO in an amount (mol. %) of 0, >0, at least 0.1, at least 0.2, at least 0.3, at least 0.4, at least 0.5, at least 0.6, at least 0.8, at least 1, at least 1.2, at least 1.4, at least 1.6, at least 1.8, 2 or less, 1.8 or less, 1.6 or less, 1.4 or less, 1.2 or less, 1 or less, 0.8 or less, 0.6 or less, 0.5 or less, 0.4 or less, 0.3 or less, 0.2 or less, 0.1 or less, or any range formed therefrom. For example, in some aspects, the glass compositions comprise SrO in an amount (mol. %) of 0-2, 0-1.8, 0-1.6, 0-1.4, 0-1.2, 0-1, 0-0.8, 0-0.6, 0-0.5, 0-0.4, 0-0.3, 0-0.2, 0-0.1, >0-2, >0-1.8, >0-1.6, >0-1.4, >0-1.2, >0-1, >0-0.8, >0-0.6, >0-0.5, >0-0.4, >0-0.3, >0-0.2, >0-0.1, 0.1-2, 0.1-1.8, 0.1-1.6, 0.1-1.4, 0.1-1.2, 0.1-1, 0.1-0.8, 0.1-0.6, 0.1-0.4, 0.1-0.2, 0.2-2, 0.2-1.8, 0.2-1.6, 0.2-1.4, 0.2-1.2, 0.2-1, 0.2-0.8, 0.2-0.6, 0.2-0.5, 0.2-0.4, 0.2-0.3, 0.3-2, 0.3-1.8, 0.3-1.6, 0.3-1.4, 0.3-1.2, 0.3-1, 0.3-0.8, 0.3-0.6, 0.3-0.5, 0.3-0.4, 0.4-2, 0.4-1.8, 0.4-1.6, 0.4-1.4, 0.4-1.2, 0.4-1, 0.4-0.8, 0.4-0.6, 0.4-0.5, 0.5-2, 0.5-1.8, 0.5-1.6, 0.5-1.4, 0.5-1.2, 0.5-1, 0.5-0.8, 0.5-0.6, 0.6-2, 0.6-1.8, 0.6-1.6, 0.6-1.4, 0.6-1.2, 0.6-1, 0.6-0.8, 0.8-2, 0.8-1.8, 0.8-1.6, 0.8-1.4, 0.8-1.2, 0.8-1, 1-2, 1-1.8, 1-1.6, 1-1.4, 1-1.2, 1.2-2, 1.2-1.8, 1.2-1.6, 1.2-1.4, 1.4-2, 1.4-1.8, 1.4-1.6, 1.6-2, 1.6-1.8, or 1.8-2. In particular, in some aspects, the glass compositions comprise SrO in an amount (mol. %) of 0-0.5, >0-0.5, 0.1-0.3, >0-0.4, or 0-0.5. In some aspects, the glass compositions are free of, or substantially free of, SrO.

In some aspects, the glass compositions, glass-based substrates, or a glass having the same composition and microstructure as the glass composition at the center of a glass-based article, have a Young's modulus (GPa) of at least 72, at least 73, at least 74, at least 75, at least 76, at least 77, at least 78, at least 79, at least 79.5, at least 80, at least 80.5, at least 81, at least 81.5, at least 82, 82.5 or less, 82 or less, 81.5 or less, 81 or less, 80.5 or less, 80 or less, 79.5 or less, 79 or less, 78 or less, 77 or less, 76 or less, 75 or less, 74 or less, 73 or less, or any range formed therefrom. For example, in some aspects, the Young's modulus (GPa) is 72-82.5, 72-82, 72-81.5, 72-81, 72-80.5, 72-80, 72-79.5, 72-79, 72-78, 72-77, 72-76, 72-75, 72-74, 72-73, 73-82.5, 73-82, 73-81.5, 73-81, 73-80.5, 73-80, 73-79.5, 73-79, 73-78, 73-77, 73-76, 73-75, 73-74, 74-82.5, 74-82, 74-81.5, 74-81, 74-80.5, 74-80, 74-79.5, 74-79, 74-78, 74-77, 74-76, 74-75, 75-82.5, 75-82, 75-81.5, 75-81, 75-80.5, 75-80, 75-79.5, 75-79, 75-78, 75-77, 75-76, 76-82.5, 76-82, 76-81.5, 76-81, 76-80.5, 76-80, 76-79.5, 76-79, 76-78, 76-77, 77-82.5, 77-82, 77-81.5, 77-81, 77-80.5, 77-80, 77-79.5, 77-79, 77-78, 78-82.5, 78-82, 78-81.5, 78-81, 78-80.5, 78-80, 78-79.5, 78-79, 79-82.5, 79-82, 79-81.5, 79-81, 79-80.5, 79-80, 79-79.5, 79.5-82.5, 79.5-82, 79.5-81.5, 79.5-81, 79.5-80.5, 79.5-80, 80-82.5, 80-82, 80-81.5, 80-81, 80-80.5, 80.5-82.5, 80.5-82, 80.5-81.5, 80.5-81, 81-82.5, 81-82, 81-81.5, 81.5-82.5, 81.5-82, or 82-82.5. In particular, in some aspects, the Young's modulus (GPa) is 75-82.5, 76-82, 72-82, 73-81.5, 75-81, or 76-80.

In some aspects, the glass compositions have any suitable anneal point. Without wishing to be bound by theory, it is believed that having a suitable anneal point, such as 685° C. or less or 675° C. or less (or any other value disclosed herein), facilitates 3D formability. The anneal points can be measured by beam bending viscosity (BBV) or fiber elongation (FE). Unless otherwise specified herein, the anneal points refer to BBV anneal points. In some aspects, the glass compositions have an anneal point (° C.) of at least 600, at least 610, at least 620, at least 630, at least 640, at least 650, at least 660, at least 670, at least 675, at least 680, 685 or less, 680 or less, 675 or less, 670 or less, 660 or less, 650 or less, 640 or less, 630 or less, 620 or less, 610 or less, or any range formed therefrom. For example, in some aspects, the glass compositions have an anneal point (° C.) of 600-685, 600-680, 600-675, 600-670, 600-660, 600-650, 600-640, 600-630, 600-620, 600-610, 610-685, 640-680, 610-675, 610-670, 610-660, 610-650, 610-640, 610-630, 610-620, 620-685, 620-680, 620-675, 620-670, 620-660, 620-650, 620-640, 620-630, 630-685, 630-680, 630-675, 630-670, 630-660, 630-650, 630-640, 640-685, 640-680, 640-675, 640-670, 640-660, 640-650, 650-685, 650-680, 650-675, 650-670, 650-660, 660-685, 660-680, 660-675, 660-670, 670-685. 670-680, 670-675, 675-685, 675-680, or 680-685. In particular, in some aspects, the glass compositions have an anneal point (° C.) of 600-685, 600-680, 600-675, 600-670, 600-660, 600-650, 600-640, 600-630, 600-620, 600-610, 610-685, 610-680, 610-675, 610-670, 610-660, 610-650, 610-640, 610-630, 610-620, 620-685, 620-680, 620-675, 620-670, 620-660, 620-650, 620-640, 620-630, 630-685, 630-680, 630-675, 630-670, 630-660, 630-650, 630-640, 640-685, 640-680, 640-675, 640-670, 640-660, 640-650, 650-685, 650-680, 650-675, 650-670, 650-660, 660-685, 660-680, 660-675, 660-670, 670-685, 670-680, 670-675, 675-685, 675-680, or 680-685.

In some aspects, the glass compositions described herein may be selected to have liquidus viscosities that are compatible with existing glass forming techniques.

In some aspects, the glass compositions have any suitable liquidus viscosity. In some aspects, the glass compositions have a liquidus viscosity (poise) of at least 2800, at least 3000, at least 3500, at least 4000, at least 4500, at least 5000, at least 6000, at least 8000, at least 10000, at least 12000, at least 14000, at least 16000, at least 18000, at least 20000, at least 22000, at least 24000, at least 26000, at least 28000, at least 30000, at least 32000, at least 34000, at least 38000, 40000 or less, 38000 or less, 36000 or less, 34000 or less, 32000 or less, 30000 or less, 28000 or less, 26000 or less, 24000 or less, 22000 or less, 20000 or less, 18000 or less, 16000 or less, 14000 or less, 12000 or less, 10000 or less, 8000 or less, 6000 or less, 5000 or less, 4500 or less, 4000 or less, 3500 or less, 3000 or less, or any range formed therefrom. For example, in some aspects, the glass compositions have a liquidus viscosity (poise) of 2800-40000, 3000-38000, 2800-12000, 2800-10000, 2800-8000, 2800-6000, 2800-5000, 2800-4500, 2800-4000, 2800-3500, 2800-3000, 3000-12000, 3000-10000, 3000-8000, 3000-6000, 3000-5000, 3000-4500, 3000-4000, 3000-3500, 3500-12000, 3500-10000, 3500-8000, 3500-6000, 3500-5000, 3500-4500, 3500-4000, 4000-12000, 4000-10000, 4000-8000, 4000-6000, 4000-5000, 4000-4500, 4500-12000, 4500-10000, 4500-8000, 4500-6000, 4500-5000, 5000-12000, 5000-10000, 5000-8000, 5000-6000, 6000-12000, 6000-10000, 6000-8000, or 8000-12000. In particular, in some aspects, the glass compositions have a liquidus viscosity (poise) of 3000-12000, 3000-8000, or 3500-6000.

In some aspects, the glass compositions have any suitable liquidus temperature. For example, in some aspects, the liquidus temperature (° C.) is at least 1000, at least 1050, at least 1100, at least 1150, at least 1200, at least 1250, at least 1300, at least 1350, at least 1400, at least 1450, 1500 or less, 1450 or less, 1400 or less, 1350 or less, 1300 or less, 1250 or less, 1200 or less, 1150 or less, 1100 or less, 1050 or less, 1000 or less, or any range formed therefrom. For example, in some aspects, the glass compositions have a liquidus temperature (° C.) of 1000-1500, 1000-1450, 1000-1400, 1000-1350, 1000-1300, 1000-1250, 1000-1200, 1000-1150, 1000-1100, 1000-1050, 1050-1500, 1050-1450, 1050-1400, 1050-1350, 1050-1300, 1050-1250, 1050-1200, 1050-1150, 1050-1100, 1100-1500, 1100-1450, 1100-1400, 1100-1350, 1100-1300, 1100-1250, 1100-1200, 1100-1150, 1150-1500, 1150-1450, 1150-1400, 1150-1350, 1150-1300, 1150-1250, 1150-1200, 1200-1500, 1200-1450, 1200-1400, 1200-1350, 1200-1300, 1200-1250, 1250-1500, 1250-1450, 1250-1400, 1250-1350, 1250-1300, 1300-1500, 1300-1450, 1300-1400, 1300-1350, 1350-1500, 1350-1450, 1350-1400, 1400-1500, 1400-1450, or 1450-1500. In particular, in some aspects, the glass compositions have a liquidus temperature of 1000-1350, 1100-1300, or 1150-1300.

In some aspects, the glass compositions described herein may form glass-based substrates or glass-based articles that exhibit an amorphous microstructure and may be substantially free of crystals or crystallites. In other words, in some aspects, the glass-based substrates or glass-based articles formed from the glass compositions described herein may exclude ceramic or glass-ceramic materials. In other aspects, the glass compositions described herein may form glass-based substrates or glass-based articles that comprise crystals or crystallites, such that the glass-based substrates or glass-based articles in some aspects include ceramic or glass-ceramic materials.

Compressive stress layers may be formed in a glass-based substrate by exposing the glass-based substrate to one or more ion exchange media. For example, in some aspects, disclosed is a method for ion-exchanging a glass-based substrate, the method comprising:
ion-exchanging a glass-based substrate in a first molten salt bath for a first time period and at a first temperature to form a glass-based article,
wherein the glass-based article comprises:
   a compressive stress layer extending from a surface of the glass-based article to a depth of compression,
   a potassium layer extending from the surface of the glass-based article to a potassium depth of layer; and
   a central tension region.

The glass-based substrate used in the method for ion-exchanging employs the same glass composition described elsewhere herein.

In some aspects, an ion exchange medium may be a molten salt bath, such as a bath containing a molten nitrate salt. In some aspects, an ion exchange medium may be a molten salt bath (e.g., the first molten salt bath) including KNO₃, NaNO₃, K₂CO₃, Na₂CO₃, or any combination thereof. In some aspects, other sodium and potassium salts may be used in an ion exchange medium, such as, for example sodium or potassium nitrites, phosphates, or sulfates. In some aspects, an ion exchange medium may include lithium salts, such as LiNO₃. An ion exchange medium may additionally include additives commonly included when ion exchanging glass, such as silicic acid. In some aspects, the ion exchange process is applied to a glass-based substrate to form a glass-based article that includes a compressive stress layer extending from a surface of the glass-based article to a depth of compression and a central tension region. The glass-based substrate utilized in an ion exchange process may comprise any of the glass compositions described herein. In some aspects, a single molten salt bath (e.g., the first molten salt bath) may be used to ion exchange a glass-based substrate. In some aspects, more than one molten salt bath (e.g., the first molten salt bath followed by a second, third, or fourth molten salt bath) may be used to ion exchange a glass-based substrate. Any of the disclosures herein relating to a molten salt bath or first molten salt bath may be equally applied to, and used to describe, a second or subsequent molten salt bath(s).

In some aspects, a molten salt bath (e.g., the first molten salt bath) comprises KNO₃. In some aspects, the amount (wt. %) of KNO₃ is at least 80, at least 82, at least 84, at least 86, at least 88, at least 90, at least 92, at least 94, at least 96, at least 98, at least 99, 100 or less, 99 or less, 98 or less, 96 or less, 94 or less, 92 or less, 90 or less, 88 or less, 86 or less, 84 or less, 82 or less, or any range formed therefrom. For example, in some aspects, a molten salt bath (e.g., the first molten salt bath) comprises KNO₃ in an amount (wt. %) of 80-100, 80-99, 80-98, 80-96, 80-94, 80-92, 80-90, 80-88, 80-86, 80-84, 80-82, 82-100, 82-99, 82-98, 82-96, 82-94, 82-92, 82-90, 82-88, 82-86, 82-84, 84-100, 84-99, 84-98, 84-96, 84-94, 84-92, 84-90, 84-88, 84-86, 86-100, 86-99, 86-98, 86-96, 86-94, 86-92, 86-90, 86-88, 88-100, 88-99, 88-98, 88-96, 88-94, 88-92, 88-90, 90-100, 90-99, 90-98, 90-96, 90-94, 90-92, 92-100, 92-99, 92-98, 92-96, 92-94, 94-100, 94-99, 94-98, 94-96, 96-100, 96-99, 96-98, 98-100, 98-99, or 99-100. In particular, in some aspects, a molten salt bath (e.g., the first molten salt bath) comprises KNO₃ in an amount (wt. %) 90-100, 96-100, or 94-99. It is explicitly contemplated that KNO₃ can be present in a molten salt bath with any other component mentioned herein, such as K₂CO₃ and/or silicic acid, for example, in any of the amounts disclosed for such components.

In some aspects, a molten salt bath (e.g., the first molten salt bath) comprises K₂CO₃. In some aspects, the amount (wt. %) of K₂CO₃ is 0, >0, at least 1, at least 2, at least 4, at least 6, at least 8, at least 10, at least 12, at least 14, at least 16, at least 18, 20 or less, 18 or less, 16 or less, 14 or less, 12 or less, 10 or less, 8 or less, 6 or less, 4 or less, 2 or less, 1 or less, or any range formed therefrom. For example, in some aspects, the amount (wt. %) of K₂CO₃ in a molten salt bath (e.g., the first molten salt bath) is 0-20, 0-18, 0-16, 0-14, 0-12, 0-10, 0-8, 0-6, 0-4, 0-2, 0-1, >0-20, >0-18, >0-16, >0-14, >0-12, >0-10, >0-8, >0-6, >0-4, >0-2, >0-1, 1-20, 1-18, 1-16, 1-14, 1-12, 1-10, 1-8, 1-6, 1-4, 1-2, 2-20, 2-18, 2-16, 2-14, 2-12, 2-10, 2-8, 2-6, 2-4, 4-20, 4-18, 4-16, 4-14, 4-12, 4-10, 4-8, 4-6, 6-20, 6-18, 6-16, 6-14, 6-12, 6-10, 6-8, 8-20, 8-18, 8-16, 8-14, 8-12, 8-10, 10-20, 10-18, 10-16, 10-14, 10-12, 12-20, 12-18, 12-16, 12-14, 14-20, 14-18, 14-16, 16-20, 16-18, or 18-20. In particular, in some aspects, a molten salt bath (e.g., the first molten salt bath) comprises K₂CO₃ in an amount of >0-6, 1-4, or 2-8. It is explicitly contemplated that KNO₃ can be present in a molten salt bath with any other component mentioned herein, such as K₂CO₃ and/or silicic acid, for example, in any of the amounts disclosed for such components. In some aspects, a molten salt bath (e.g., the first molten salt bath) is free of, or substantially free of, K₂CO₃.

In some aspects, a molten salt bath (e.g., the first molten salt bath) comprises silicic acid. In some aspects, silicic acid may be employed in a molten salt bath to neutralize alkali metal oxides present in the molten salt bath resulting from degradation of the surface of a glass during ion exchange. As used herein, the term “silicic acid” may refer to silicic acids, such as orthosilicic acid (Si(OH)₄), as well as the corresponding silicates, which are the conjugate bases of silicic acids. Silicic acids generally react with alkali metal oxides to form an unreactive product, as indicated in the following equation: M₂O+SiO₂→M₂SiO₃, in which M is a Group I metal. In some aspects, a molten salt bath includes silicic acid in an amount (wt. %) of 0, >0, at least 0.1, at least 0.2, at least 0.4, at least 0.6, at least 0.8, at least 1, at least 1.2, at least 1.4, at least 1.6, at least 1.8, 2 or less, 1.8 or less, 1.6 or less, 1.4 or less, 1.2 or less, 1 or less, 0.8 or less, 0.6 or less, 0.4 or less, 0.2 or less, 0.1 or less, or any range formed therefrom. For example, in some aspects, a molten salt bath in an amount (wt. %) of 0-2, 0-1.8, 0-1.6, 0-1.4, 0-1.2, 0-1, 0-0.8, 0-0.6, 0-0.4, 0-0.2, 0-0.1, >0-2, >0-1.8, >0-1.6, >0-1.4, >0-1.2, >0-1, >0-0.8, >0-0.6, >0-0.4, >0-0.2, >0-0.1, 0.1-2, 0.1-1.8, 0.1-1.6, 0.1-1.4, 0.1-1.2, 0.1-1, 0.1-0.8, 0.1-0.6, 0.1-0.4, 0.1-0.2, 0.2-2, 0.2-1.8, 0.2-1.6, 0.2-1.4, 0.2-1.2, 0.2-1, 0.2-0.8, 0.2-0.6, 0.2-0.4, 0.4-2, 0.4-1.8, 0.4-1.6, 0.4-1.4, 0.4-1.2, 0.4-1, 0.4-0.8, 0.4-0.6, 0.6-2, 0.6-1.8, 0.6-1.6, 0.6-1.4, 0.6-1.2, 0.6-1, 0.6-0.8, 0.8-2, 0.8-1.8, 0.8-1.6, 0.8-1.4, 0.8-1.2, 0.8-1, 1-2, 1-1.8, 1-1.6, 1-1.4, 1-1.2, 1.2-2, 1.2-1.8, 1.2-1.6, 1.2-1.4, 1.4-2, 1.4-1.8, 1.4-1.6, 1.6-2, 1.6-1.8, or 1.8-2. In particular, in some aspects, a molten salt bath comprises silicic acid in an amount (wt. %) of 0.1-1, 0.2-0.8, or 0.4-0.6. In some aspects, a molten salt bath is free of, or substantially free of, silicic acid.

In some aspects, a time period for ion exchange (e.g., the first time period) can be any suitable time period sufficient to create the desired extent of ion exchange in a glass-based substrate so as to create a glass-based article. For example, in some aspects, the time period, such as the first time period, (hours) is at least 3, at least 4, at least 6, at least 8, at least 10, at least 12, at least 14, at least 16, at least 18, at least 20, at least 22, at least 24, 26 or less, 24 or less, 22 or less, 20 or less, 18 or less, 16 or less, 14 or less, 12 or less, 10 or less, 8 or less, 6 or less, 4 or less, or any range formed therefrom. For example, in some aspects, the time period, such as the first time period, (hours) is 3-26, 3-24, 3-22, 3-20, 3-18, 3-16, 3-14, 3-12, 3-10, 3-8, 3-6, 3-4, 4-26, 4-24, 4-22, 4-20, 4-18, 4-16, 4-14, 4-12, 4-10, 4-8, 4-6, 6-26, 6-24, 6-22, 6-20, 6-18, 6-16, 6-14, 6-12, 6-10, 6-8, 8-26, 8-24, 8-22, 8-20, 8-18, 8-16, 8-14, 8-12, 8-10, 10-26, 10-24, 10-22, 10-20, 10-18, 10-16, 10-14, 10-12, 12-26, 12-24, 12-22, 12-20, 12-18, 12-16, 12-14, 14-26, 14-24, 14-22, 14-20, 14-18, 14-16, 16-26, 16-24, 16-22, 16-20, 16-18, 18-26, 18-24, 18-22, 18-20, 20-26, 20-24, 20-22, 22-26, 22-24, or 24-26. In particular, in some aspects, the time period, such as the first time period, (hours) is 3-12, 4-10, 6-10, or 3-16.

In some aspects, a temperature for ion exchange (e.g., the first temperature) can be any suitable temperature sufficient to create the desired extent of ion exchange in a glass-based substrate so as to create a glass-based article. For example, in some aspects, the temperature, such as the first temperature, (° C.) is at least 340, at least 360, at least 380, at least 400, at least 420, at least 440, at least 460, at least 480, at least 500, 520 or less, 500 or less, 480 or less, 460 or less, 440 or less, 420 or less, 400 or less, 380 or less, 360 or less, or any range formed therefrom. For example, in some aspects, the temperature (e.g., the first temperature) (° C.) is 340-520, 340-500, 340-480, 340-460, 340-440, 340-420, 340-400, 340-380, 340-360, 360-520, 360-500, 360-480, 360-460, 360-440, 360-420, 360-400, 360-380, 380-520, 380-500, 380-480, 380-460, 380-440, 380-420, 380-400, 400-520, 400-500, 400-480, 400-460, 400-440, 400-420, 420-520, 420-500, 420-480, 420-460, 420-440, 440-520, 440-500, 440-480, 440-460, 460-520, 460-500, 460-480, 480-520, 480-500, or 500-520. In particular, in some aspects, the temperature (e.g., first temperature) (° C.) is 340-500, 360-460, or 360-420.

In some aspects, ion exchanging a glass-based substrate in one or more ion exchange media (e.g., one or more molten salt baths) results in a potassium layer extending from the surface of the glass-based article to a potassium depth of layer (DOL) of any suitable depth. For example, in some aspects, the DOL (m) of a glass-based article is at least 15, at least 20, at least 25, at least 30, at least 35, at least 40, at least 45, 50 or less, 45 or less, 40 or less, 35 or less, 30 or less, 25 or less, 20 or less, or any range formed therefrom. For example, in some aspects, the DOL is 15-50, 15-45, 15-40, 15-35, 15-30, 15-25, 15-20, 20-50, 20-45, 20-40, 20-35, 20-30, 20-25, 25-50, 25-45, 25-40, 25-35, 25-30, 30-50, 30-45, 30-40, 30-35, 35-50, 35-45, 35-40, 40-50, 40-45, or 45-50. In particular, in some aspects, the DOL is 15-50, 15-35, or 20-45.

In some aspects, disclosed is a glass-based article, comprising:
a compressive stress layer extending from a surface of the glass-based article to a depth of compression;
a potassium layer extending from the surface of the glass-based article to a potassium depth of layer (DOL);
a central tension region;
a thickness; and
a glass composition at a center of the glass-based article comprising:
   40-60 mol. % SiO₂;
   14-30 mol. % Al₂O₃;
   1-10 mol. % Li₂O;
   15-30 mol. % Na₂O;
   1-20 mol. % MgO;
   0-10 mol. % CaO; and
   0-5 mol. % P₂O₅.

Generally, the glass-based substrates and glass compositions described elsewhere herein are employed to prepare the glass-based articles. As a result, various disclosures elsewhere herein are equally applicable to the glass-based articles and therefore relevant disclosures are not repeated. For example, the glass composition at a center of the glass-based article generally is the same composition disclosed elsewhere herein that is used to form the glass-based substrate, which glass-based substrate is subjected to ion exchange to result in a glass-based article. Accordingly, the compositions disclosed elsewhere herein are applicable to the center of the glass-based article (which generally does not experience ion exchange in the molten salt bath under the conditions employed, such that the center is the same as the original composition of the starting glass-based substrate prior to ion exchange). Similarly, some features described herein for the glass-based article are equally applicable to the glass-based substrate (e.g., thickness). In some aspects, glass-based substrates and/or glass-based articles contain a surface coating, which in some aspects may be a polymeric coating. In some aspects, glass-based substrates and/or glass-based articles are free of a surface coating.

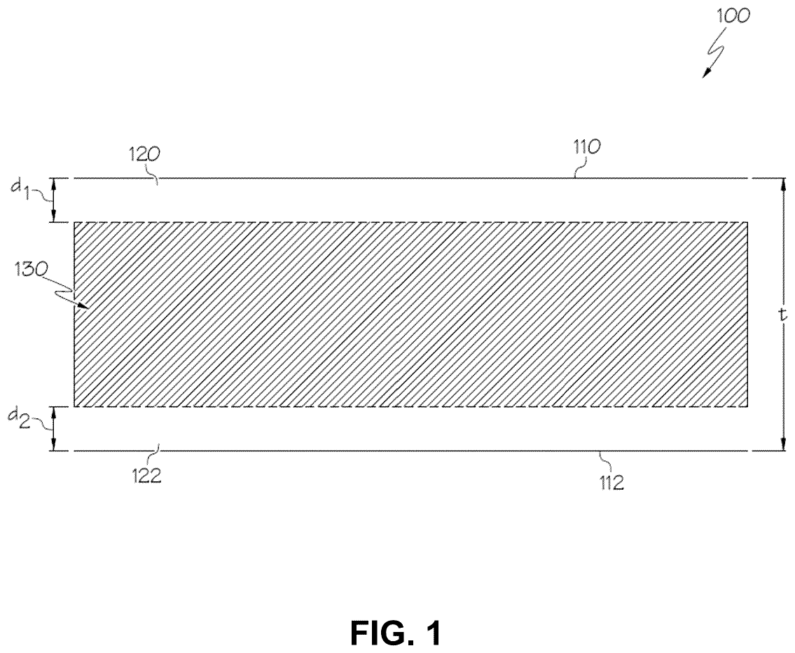

As mentioned elsewhere herein, the glass compositions described herein can be strengthened, such as by ion exchange, making a glass-based article that is damage resistant for applications such as, but not limited to, display covers, window covers (e.g., for glasses or goggles), or housings (e.g., for consumer electronic devices). With reference to FIG. 1, a glass-based article is depicted that has a first region under compressive stress (e.g., first and second compressive layers 120, 122 in FIG. 1) extending from the surface to a depth of compression (DOC) of the glass-based article and a second region (e.g., central region 130 in FIG. 1) under a tensile stress or central tension (CT) extending from the DOC into the central or interior region of the glass-based article. As used herein, DOC refers to the depth at which the stress within the glass-based article changes from compressive to tensile. At the DOC, the stress crosses from a positive (compressive) stress to a negative (tensile) stress and thus exhibits a stress value of zero.

According to the convention normally used in the art, compression or compressive stress is expressed as a negative (<0) stress and tension or tensile stress is expressed as a positive (>0) stress. Throughout this description, however, unless clearly contradicted by context, CS is expressed as a positive or absolute value—i.e., as recited herein, CS=|CS|. The compressive stress (CS) has a maximum at or near the surface of the glass-based article, and the CS varies with distance d from the surface according to a function. Referring again to FIG. 1, a first segment 120 extends from first surface 110 to a depth d₁ and a second segment 122 extends from second surface 112 to a depth d₂. Together, these segments define a compression or CS of glass-based article 100. The surface compressive stress (CS) may be measured using a scattered light polariscope (SCALP) technique or a refractive near field (RNF) technique known in the art. CS values provided herein are measured using a SCALP technique, unless otherwise specified.

The compressive stress of both major surfaces (110, 112 in FIG. 1) is balanced by stored tension in the central region (130) of the glass-based article. The surface compressive stress (CS), maximum central tension (CT) and DOC values may be measured using a scattered light polariscope (SCALP) technique or a refractive near field (RNF) technique known in the art. The SCALP method or RNF method also may be used to determine the stress profile of the glass-based articles.

In some aspects, a glass-based article has a compressive stress layer comprising a maximum compressive stress (“maximum CS”). In some aspects, the maximum CS (MPa) is at least 1200, at least 1300, at least 1400, at least 1500, at least 1600, at least 1700, at least 1800, at least 1900, at least 2000, 2100 or less, 2000 or less, 1900 or less, 1800 or less, 1700 or less, 1600 or less, 1500 or less, 1400 or less, 1300 or less, or any range formed therefrom. For example, in some aspects, the maximum CS (MPa) is 1200-2100, 1200-2000, 1200-1900, 1200-1800, 1200-1700, 1200-1600, 1200-1500, 1200-1400, 1200-1300, 1300-2100, 1300-2000, 1300-1900, 1300-1800, 1300-1700, 1300-1600, 1300-1500, 1300-1400, 1400-2100, 1400-2000, 1400-1900, 1400-1800, 1400-1700, 1400-1600, 1400-1500, 1500-2100, 1500-2000, 1500-1900, 1500-1800, 1500-1700, 1500-1600, 1600-2100, 1600-2000, 1600-1900, 1600-1800, 1600-1700, 1700-2100, 1700-2000, 1700-1900, 1700-1800, 1800-2100, 1800-2000, 1800-1900, 1900-2100, 1900-2000, or 2000-2100. In particular, in some aspects, the maximum CS (MPa) is 1400-2000, 1200-1800, or 1200-1600.

In some aspects, a glass-based article has a central region comprising a maximum central tension (“maximum CT”). In some aspects, the maximum CT (MPa) is at least 20, at least 25, at least 30, at least 35, at least 40, at least 45, at least 50, at least 55, at least 60, at least 65, at least 70, at least 75, at least 80, at least 85, at least 90, at least 95, 100 or less, 95 or less, 90 or less, 85 or less, 80 or less, 75 or less, 70 or less, 65 or less, 60 or less, 55 or less, 50 or less, 45 or less, 40 or less, 35 or less, 30 or less, 25 or less, or any range formed therefrom. For example, in some aspects, the maximum CT (MPa) is 20-100, 20-95, 20-90, 20-80, 20-70, 20-60, 20-50, 20-40, 20-35, 20-30, 20-25, 25-100, 25-90, 25-80, 25-75, 25-70, 25-65, 25-60, 25-50, 25-45, 25-40, 25-30, 30-100, 30-95, 30-85, 30-80, 30-70, 30-60, 30-55, 30-45, 30-35, 35-100, 35-95, 35-85, 35-80, 35-70, 35-60, 35-55, 35-50, 35-40, 40-100, 40-95, 40-90, 40-80, 40-70, 40-65, 40-50, 40-45, 45-100, 45-95, 45-90, 45-80, 45-70, 45-60, 45-55, 45-50, 50-100, 50-90, 50-85, 50-75, 50-60, 50-55, 55-100, 55-95, 55-90, 55-80, 55-75, 55-65, 55-60, 60-100, 60-95, 60-85, 60-75, 60-70, 60-65, 65-100, 65-95, 65-90, 65-85, 65-80, 65-70, 70-100, 70-90, 70-80, 70-85, 85-100, 85-95, 85-90, 90-100, 90-95, or 95-100. In particular, in some aspects, the maximum CT (MPa) is 20-100, 30-60, or 25-50.

In some aspects, a glass-based article (or the glass-based substrate) has any suitable thickness. For example, in some aspects, the thickness (mm) is at least 0.4, at least 0.5, at least 0.6, at least 0.7, at least 0.8, at least 0.9, at least 1, at least 1.2, at least 1.4, at least 1.6, at least 1.8, at least 2, at least 2.5, at least 3, at least 3.5, at least 4, at least 4.5, 5 or less, 4.5 or less, 4 or less, 3.5 or less, 3 or less, 2.5 or less, 2 or less, 1.8 or less, 1.6 or less, 1.4 or less, 1.2 or less, 1 or less, 0.9 or less, 0.8 or less, 0.7 or less, 0.6 or less, 0.5 or less, or any range formed therefrom. For example, in some aspects, the thickness (mm) is 0.4-5, 0.4-4.5, 0.4-4, 0.4-3, 0.4-2, 0.4-1.2, 0.4-1, 0.4-1, 0.4-0.9, 0.4-0.7, 0.4-0.6, 0.4-0.5, 0.5-5, 0.5-4.5, 0.5-3.5, 0.5-2.5, 0.5-2, 0.5-1.4, 0.5-1, 0.5-0.8, 0.5-0.6, 0.6-5, 0.6-4.5, 0.6-4, 0.6-3, 0.6-2, 0.6-1.8, 0.6-1.4, 0.6-0.8, 0.6-0.7, 0.7-5, 0.7-4, 0.7-3, 0.7-2, 0.7-1.8, 0.7-1.4, 0.7-1.2, 0.7-1, 0.7-0.9, 0.8-5, 0.8-4.5, 0.8-4, 0.8-3.5, 0.8-3, 0.8-2, 0.8-1.6, 0.8-1.4, 0.8-1, 0.9-5, 0.9-4, 0.9-3, 0.9-2.5, 0.9-1.8, 0.9-1.6, 0.9-1.2, 1-5, 1-4.5, 1-3.5, 1-2.5, 1-2, 1-1.8, 1-1.6, 1-1.4, 1-1.2, 1.2-5, 1.2-4.5, 1.2-3, 1.2-2.5, 1.2-2, 1.2-1.8, 1.2-1.6, 1.2-1.4, 1.4-5, 1.4-4, 1.4-3, 1.4-2.5, 1.4-2, 1.4-1.8, 1.4-1.6, 1.6-5, 1.6-4, 1.6-3.5, 1.6-2.5, 1.6-1.8, 1.8-5, 1.8-4, 1.8-3, 1.8-2.5, 2-5, 2-4.5, 2-4, 2-3.5, 2-3, 2.5-5, 2.5-4.5, 2.5-4, 2.5-3.5, 2.5-3, 3-5, 3-4.5, 3-4, 3-3.5, 3.5-5, 3.5-4.5, 3.5-4, 4-5, 4-4.5, or 4.5-5. In particular, in some aspects, the thickness (mm) is 0.4-5, 0.4-2, 0.4-1.4, or 0.6-1.2. For clarity, it is noted that thickness can be paired with DOL, maximum CT, maximum CS, or any other features disclosed elsewhere herein to describe a glass-based article.

In some aspects, a glass-based article has any combination of maximum CS, DOL, thickness, and any other features disclosed elsewhere herein. For example, in some aspects, a glass-based article has a maximum CS of at least 1400 MPa (e.g., 1400-2000 MPa), a DOL of at least 20 microns (e.g., 20-50 microns), and a thickness of 0.6-1 mm (e.g., 0.4-3 mm). Any other values disclosed elsewhere herein may be combined in any manner.

In some aspects, a glass-based article is non-frangible. Frangibility is described elsewhere herein.

In some aspects, a glass-based article has as-good-as or even improved mechanical properties relative to a glass-based article having a concentration of Li₂O outside the range of 1-10 mol. % Li₂O and/or a concentration of Na₂O outside the range of 15-30 mol. % Na₂O and prepared with two or more ion exchange processes. In some aspects, a glass-based article has improved (greater) Vickers Hardness Number (VHN) and/or improved (greater) Knoop Hardness Number (KHN). In some aspects, a glass-based article has a comparable stress profile and a comparable retained strength in flaw depths, e.g., up to 10 μm or up to 15 μm. In some aspects, a glass-based article has an improved (greater initial) stress profile and a comparable retained strength in flaw depths e.g., up to 10 μm or up to 15 μm. In some aspects, a glass-based article has an improved (greater initial) stress profile an improved (greater) retained strength in flaw depths e.g., up to 10 μm or up to 15 μm. In some aspects, the glass-based article has a retained strength at the surface of at least 2500 MPa, at least 4000 MPa, or at least 5500 MPa, for example in a range of about 2500 MPa to about 7000 MPa, about 2500 MPa to about 6500 MPa, about 2500 MPa to about 6400 MPa, about 2500 MPa to about 6000 MPa, about 2500 MPa to about 5900 MPa, about 2500 MPa to about 5500 MPa, about 2500 MPa to about 5000 MPa, about 2500 MPa to about 4000 MPa, about 2500 MPa to about 3000 MPa, or about 5500 MPa to about 6500 MPa. In some aspects, the glass-based article has a retained strength of at least 1250 MPa at a flaw depth of 10 micron, for example, in a range of about 1250 MPa to about 1350 MPa, or in a range of about 1250 MPa to about 1300 MPa. In some aspects, the glass-based article has a retained strength of at least 700 MPa at a flaw depth of 15 micron, for example, about 700 MPa to about 800 MPa.

The Vickers Hardness distribution measurements described herein are performed according to ASTM C1327, using an indentation load of 200 grams. The indentation load is held for 10 seconds. After removing the load, the lengths of the two diagonals of the resulting square indentation is measured. The VHN is calculated using the applied load and average length of the measured diagonals: VHN=(load/surface area of indentation). All indentation measurements are performed at room temperature in 50% relative humidity.

The Knoop Hardness distribution measurements described herein are performed according to ASTM C1326(2018), using an applied load of 200 grams and a hold time of 10 seconds. The KHN is calculated using the applied load and projected area of the indentation: KHN=P/Ap, where P is the applied load and Ap is the projected area of the indentation. The projected area is calculated based on the long diagonal length and the known geometry of the Knoop indenter. All indentation measurements are performed at room temperature in 50% relative humidity.

As shown in the examples herein, advantageously, glass-based articles according to the disclosure prepared with a single ion exchange process can have comparable or improved mechanical properties relative to glass-based articles that have been toughened with two or more ion exchange processes. Without intending to be bound by theory, it is believed that the improvement in mechanical properties is a result of a glass-based article having sodium and lithium concentrations as disclosed herein being ion exchanged under the conditions disclosed herein.

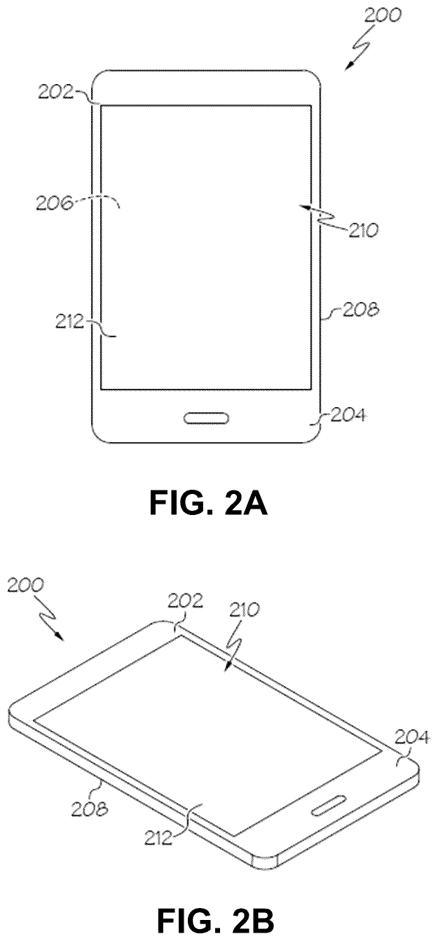

In some aspects, the glass-based articles disclosed herein may be incorporated into another article such as an article with a display or window (e.g., consumer electronics, including glasses or goggles such as augmented reality glasses or goggles, mobile phones, tablets, computers, navigation systems, and the like), architectural articles, transportation articles (e.g., automobiles, trains, aircraft, sea craft, etc.), appliance articles, or any article that requires some transparency, scratch-resistance, abrasion resistance or a combination thereof. An exemplary article incorporating any of the glass-based articles disclosed herein is shown in FIGS. 2A and 2B. Specifically, FIGS. 2A and 2B show a consumer electronic device 200 including a housing 202 having front 204, back 206, and side surfaces 208; electrical components (not shown) that are at least partially inside or entirely within the housing and including at least a controller, a memory, and a display 210 at or adjacent to the front surface of the housing; and a cover 212 at or over the front surface of the housing such that it is over the display. In some aspects, at least a portion of at least one of the cover 212 and the housing 202 may include any of the glass-based articles described herein.

In some aspects, the glass-based articles disclosed herein may be incorporated into augmented reality goggles (which includes goggles, glasses, headsets, visors, and so forth). For example, in some aspects, the disclosed is augmented reality goggles comprises electrical components comprising a display, and a glass-based article disposed over the display. The glass-based article can be any glass-based article disclosed herein.

Various aspects are contemplated herein, several of which are set forth in the paragraphs below. It is explicitly contemplated that any aspect or portion thereof can be combined to form a combination. The phrase “any other aspect herein” means any numbered aspect herein, or any aspect or aspects disclosed elsewhere herein.

Aspect 1. A glass composition, comprising:
40-60 mol. % SiO₂;
14-30 mol. % Al₂O₃;
1-10 mol. % Li₂O;
15-30 mol. % Na₂O;
1-20 mol. % MgO;
0-10 mol. % CaO;
0-5 mol. % P₂O₅; and
a Young's modulus of 82 GPa or less.

Aspect 2. The glass composition of any preceding aspect, or any other aspect herein, comprising 2-10 mol. % Li₂O.

Aspect 3. The glass composition of any preceding aspect, or any other aspect herein, comprising 0-1 mol. % P₂O₅.

Aspect 4. The glass composition of any preceding aspect, or any other aspect herein, comprising TiO₂.

Aspect 5. The glass composition of any preceding aspect, or any other aspect herein, comprising:
R₂O/Al₂O₃ of 1-1.5, wherein amounts are in mol. %, and R₂O is total amount of Li₂O, Na₂O, K₂O, Rb₂O, and Cs₂O;
R₂O of 19-30 mol. %;
Al₂O₃+MgO of 20-30 mol. %; or
any combination thereof;
wherein amounts are in mol. %, and R₂O is total amount of Li₂O, Na₂O, K₂O, Rb₂O, and Cs₂O.

Aspect 6. The glass composition of any preceding aspect, or any other aspect herein, comprising:
50-60 mol. % SiO₂;
15-25 mol. % Al₂O₃;
2-5 mol. % Li₂O;
15-25 mol. % Na₂O;
1-10 mol. % MgO;
0-5 mol. % CaO; or
any combination thereof.

Aspect 7. The glass composition of any preceding aspect, or any other aspect herein, comprising:
0-1 mol. % SnO₂;
0-5 mol. % B₂O₃;
0-2 mol. % K₂O;
0-2 mol. % SrO; or
any combination thereof.

Aspect 8. The glass composition of any preceding aspect, or any other aspect herein, comprising a Young's modulus of 81 GPa or less.

Aspect 9. The glass composition of any preceding aspect, or any other aspect herein, comprising an anneal point of 675° C. or less as measured by beam bending viscosity.

Aspect 10. A method for ion-exchanging a glass-based substrate, the method comprising:
ion-exchanging the glass-based substrate in a first molten salt bath for a first time period and at a first temperature to form a glass-based article,
wherein the glass-based article comprises:
   a compressive stress layer extending from a surface of the glass-based article to a depth of compression,
   a potassium layer extending from the surface of the glass-based article to a potassium depth of layer; and
   a central tension region, and
the glass-based substrate comprises the glass composition of any preceding aspect, or any other aspect herein.

Aspect 11. The method of aspect 10, any preceding aspect, or any other aspect herein, wherein the first molten salt bath comprises KNO₃ and optionally K₂CO₃.

Aspect 12. The method of aspect 10 or 11, any preceding aspect, or any other aspect herein, wherein the first time period is 3-12 hours.

Aspect 13. The method of any one of aspects 10-12, any preceding aspect, or any other aspect herein, wherein the first temperature is 340-500° C.

Aspect 14. The method of any one of aspects 10-13, any preceding aspect, or any other aspect herein, wherein the potassium depth of layer is 15-50 microns.

Aspect 15. The method of any one of aspects 10-14, wherein the method does not include more than one ion-exchange step.

Aspect 16. A glass-based article, comprising:
a compressive stress layer extending from a surface of the glass-based article to a depth of compression;
a potassium layer extending from the surface of the glass-based article to a potassium depth of layer;
a central tension region;
a thickness; and
a glass composition at a center of the glass-based article comprising the glass composition of any one of aspects 1-9, any preceding aspect, or any other aspect herein, or the glass composition comprising:
   40-60 mol. % SiO₂;
   14-30 mol. % Al₂O₃;
   1-10 mol. % Li₂O;
   15-30 mol. % Na₂O;
   1-20 mol. % MgO;
   0-10 mol. % CaO; and
   0-5 mol. % P₂O₅;
   wherein a glass having the same composition and microstructure as the glass composition at the center of the glass-based article has a Young's modulus of 82 GPa or less.

Aspect 17. The glass-based article of aspect 16, any preceding aspect, or any other aspect herein, wherein the potassium depth of layer is 15-50 microns.

Aspect 18. The glass-based article of aspect 16 or 17, any preceding aspect, or any other aspect herein, wherein the compressive stress layer comprises a maximum compressive stress of 1400-2000 MPa.

Aspect 19. The glass-based article of any one of aspects 16-18, any preceding aspect, or any other aspect herein, wherein the central tension region comprises a maximum central tension of 20-100 MPa.

Aspect 20. The glass-based article of any one of aspects 16-19, any preceding aspect, or any other aspect herein, wherein the thickness is 0.4-5 mm.

Aspect 21. The glass-based article of any one of aspects 16-20, any preceding aspect, or any other aspect herein, wherein the glass-based article is non-frangible.

Aspect 22. The glass-based article of any one of aspects 16-21, any preceding aspect, or any other aspect herein, wherein the glass composition at the center of the glass-based article comprises 2-10 mol. % Li₂O.

Aspect 23. The glass-based article of any one of aspects 16-22, any preceding aspect, or any other aspect herein, wherein the glass composition at the center of the glass-based article comprises 0-1 mol. % P₂O₅.

Aspect 24. The glass-based article of any one of aspects 16-23, any preceding aspect, or any other aspect herein, wherein the glass composition at the center of the glass-based article comprises TiO₂.

Aspect 25. The glass-based article of any one of aspects 16-24, any preceding aspect, or any other aspect herein, wherein the glass composition at the center of the glass-based article comprises:
R₂O/Al₂O₃ of 1-1.5, wherein amounts are in mol. %, and R₂O is total amount of Li₂O, Na₂O, K₂O, Rb₂O, and Cs₂O;
R₂O of 19-30 mol. %;
Al₂O₃+MgO of 20-30 mol. %; or
any combination thereof;
wherein amounts are in mol. %, and R₂O is total amount of Li₂O, Na₂O, K₂O, Rb₂O, and Cs₂O.

Aspect 26. The glass-based article of any one of aspects 16-25, any preceding aspect, or any other aspect herein, wherein the glass composition at the center of the glass-based article comprises:
50-60 mol. % SiO₂;
15-25 mol. % Al₂O₃;
2-5 mol. % Li₂O;
15-25 mol. % Na₂O;
1-10 mol. % MgO;
0-5 mol. % CaO; or
any combination thereof.

Aspect 27. The glass-based article of any one of aspects 16-26, any preceding aspect, or any other aspect herein, wherein the glass composition at the center of the glass-based article comprises:
0-1 mol. % SnO₂;
0-5 mol. % B₂O₃;
0-2 mol. % K₂O;
0-2 mol. % SrO; or
any combination thereof.

Aspect 28. The glass-based article of any one of aspects 16-27, any preceding aspect, or any other aspect herein, wherein a glass having the same composition and microstructure as the glass composition at the center of the glass-based article comprises a Young's modulus of 81 GPa or less.

Aspect 29. The glass-based article of any one of aspects 16-28, any preceding aspect, or any other aspect herein, wherein a glass having the same composition and microstructure as the glass composition at the center of the glass-based article comprises an anneal point of 675° C. or less as measured by beam bending viscosity.

Aspect 30. The glass-based article of any one of aspects 16-29, wherein the glass-based article has a Vickers Hardness Number greater than or equal to an otherwise identical glass-based article having a concentration of Li₂O outside the range of 1-10 mol. % Li₂O and/or a concentration of Na₂O outside the range of 15-30 mol. % Na₂O and prepared with two or more ion exchange processes.

Aspect 31. The glass-based article of any one of aspects 16-30, wherein the glass-based article has a Knoop Hardness Number greater than or equal to an otherwise identical glass-based article having a concentration of Li₂O outside the range of 1-10 mol. % Li₂O and/or a concentration of Na₂O outside the range of 15-30 mol. % Na₂O and prepared with two or more ion exchange processes.

Aspect 32. The glass-based article of any one of aspects 16-31, wherein the glass-based article has an initial compressive stress greater than or equal to an otherwise identical glass-based article having a concentration of Li₂O outside the range of 1-10 mol. % Li₂O and/or a concentration of Na₂O outside the range of 15-30 mol. % Na₂O and prepared with two or more ion exchange processes.

Aspect 33. The glass-based article of any one of aspects 16-32, wherein the glass-based article has a retained strength for flaw depths up to 10 μm or 15 μm greater than or equal to an otherwise identical glass-based article having a concentration of Li₂O outside the range of 1-10 mol. % Li₂O and/or a concentration of Na₂O outside the range of 15-30 mol. % Na₂O and prepared with two or more ion exchange processes.

Aspect 34. The glass-based article of any one of aspects 16-33, wherein the glass-based article has a surface and the glass-based article has a retained strength at the surface of at least 2500 MPa.

Aspect 35. The glass-based article of any one of aspects 16-34, wherein the glass-based article has a surface and the glass-based article has a retained strength at the surface of at least 5500 MPa.

Aspect 36. The glass-based article of any one of aspects 16-35, wherein the glass-based article has a retained strength of at least 1250 MPa at a flaw depth of 10 micron.

Aspect 37. The glass-based article of any one of aspects 16-36, wherein the glass-based article has a retained strength of at least 700 MPa at a flaw depth of 15 micron.

Aspect 38. Augmented reality headset, comprising:
electrical components comprising a display; and
the glass-based article of any one of aspects 16-37, any preceding aspect, or any other aspect herein, disposed over the display.

Aspect 39. A consumer electronic device, comprising:
a housing having a front surface, a back surface and side surfaces;
electrical components provided at least partially within the housing, the electrical components including at least a controller, a memory, and a display, the display being provided at or adjacent to the front surface of the housing; and
a cover substrate disposed over the display;
wherein at least a portion of at least one of the housing and the cover substrate comprises the glass-based article of any one of aspects 16-37, any preceding aspect, or any other aspect herein.

Aspect 40: A combination of any two or more preceding aspects, any other aspect herein, or any portion(s) thereof.

### Examples

The following examples illustrate non-limiting aspects of the disclosure and are not intended to be limiting on the scope of the disclosure or claims.

Example 1: This example demonstrates various glass compositions that were prepared and analyzed.

The glass compositions included the components listed in Table 1 below and were prepared by conventional glass melting and forming methods. In Table 1, all components are in mol %. The liquidus temperature and liquidus viscosity were measured according to the method described elsewhere herein. The Poisson's ratio (ν) and Young's modulus (E) of the glass compositions were measured by a resonant ultrasonic spectroscopy technique of the general type set forth in ASTM E2001-13, titled “Standard Guide for Resonant Ultrasound Spectroscopy for Defect Detection in Both Metallic and Non-metallic Parts.” The refractive index (at 589.3 nm) was measured using a PerkinElmer 950 spectrometer. The stress optical coefficient (SOC) was measured at 546.1 nm according to Procedure C (Glass Disc Method) described in ASTM standard C770-16, entitled “Standard Test Method for Measurement of Glass Stress-Optical Coefficient.” The density of the glass compositions was determined using the buoyancy method of ASTM C693-93(2013). The annealing point is the temperature at which the viscosity of the glass composition is 1×10¹³ poise, and the strain point is the temperature at which the viscosity of the glass composition is 1×10^{14.68} poise. Annealing point and strain point are measured by beam bending viscosity (BBV) or fiber elongation (FE).

TABLE 1

| Analyzed (mol %) | 1 | 2 | 3 | 4 | 5 | 6 |
|---|---|---|---|---|---|---|
| SiO₂ | 56.34 | 56.36 | 58.89 | 55.89 | 53.68 | 54.84 |
| Al₂O₃ | 18.59 | 19.01 | 18.89 | 19.31 | 19.44 | 19.39 |
| Li₂O | 2.07 | 2.05 | 2.10 | 2.07 | 2.08 | 2.02 |
| Na₂O | 18.31 | 18.12 | 16.97 | 18.28 | 18.25 | 17.79 |
| MgO | 2.31 | 2.22 | 1.52 | 4.30 | 3.24 | 4.84 |
| CaO | 2.28 | 2.14 | 1.51 | 0.04 | 3.19 | 1.01 |
| SnO₂ | 0.05 | 0.05 | 0.05 | 0.05 | 0.05 | 0.05 |
| B₂O₃ | | | | | | |
| TiO₂ | | | | | | |
| K₂O | | | | | | |
| SrO | | | | | | |
| ZnO | | | | | | |
| Minor constituents | 0.07 | 0.06 | 0.07 | 0.06 | 0.06 | 0.06 |
| SUM | 100 | 100 | 100 | 100 | 100 | 100 |
| R₂O/Al₂O₃ | 1.10 | 1.06 | 1.01 | 1.05 | 1.05 | 1.02 |
| Al₂O₃ + MgO | 20.89 | 21.22 | 20.41 | 23.61 | 22.69 | 24.23 |
| R₂O | 20.37 | 20.17 | 19.07 | 20.35 | 20.33 | 19.82 |
| Density (g/cm³) | 2.486 | 2.492 | 2.499 | 2.491 | 2.516 | 2.502 |
| BBV Strain Pt. (° C.) | 600 | 581.6 | 609.9 | 622 | 597.4 | 607.3 |
| BBV Anneal Pt. (° C.) | 647.5 | 626.2 | 657.4 | 671.6 | 643.4 | 652.9 |
| Stress Optical Coefficient | 2.782 | 2.786 | 2.757 | 2.825 | 2.711 | 2.75 |
| (nm/mm/MPa) | | | | | | |
| Refractive Index | 1.5165 | 1.5162 | 1.5178 | 1.5155 | 1.5229 | 1.5189 |
| Young's modulus (GPa) | 78.119 | 78.135 | 78.552 | 77.81 | 79.886 | 79.397 |
| Poisson's ratio | 0.214 | 0.219 | 0.22 | 0.22 | 0.22 | 0.224 |
| Fulchers A | −4.276 | −3.353 | −3.405 | −3.276 | −3.012 | −3.461 |
| Fulchers B | 10328.2 | 8098.2 | 8078.9 | 7579.2 | 6881.5 | 7853.6 |
| Fulchers Tₒ | −14 | 129.1 | 141.7 | 196.8 | 212.2 | 161 |
| 100 Poise Temperature (° C.) | 1632 | 1642 | 1636 | 1633 | 1585 | 1599 |
| 1000 Poise Temperature (° C.) | 1405 | 1404 | 1403 | 1404 | 1357 | 1377 |
| Liquidus Temperature (° C.) | 1225 | 1270 | 1155 | 1235 | 1210 | 1245 |
| Liquidus Viscosity (kP) | 11.48 | 5.56 | 36.97 | 10.58 | 7.67 | 6.08 |

| Analyzed (mol %) | 7 | 8 | 9 | 10 | 11 | 12 |
|---|---|---|---|---|---|---|
| SiO₂ | 54.14 | 53.99 | 56.41 | 54.76 | 55.79 | 53.00 |
| Al₂O₃ | 18.94 | 18.68 | 19.49 | 19.33 | 18.55 | 18.85 |
| Li₂O | 2.09 | 2.05 | 2.52 | 2.76 | 2.56 | 2.76 |
| Na₂O | 18.14 | 18.17 | 17.65 | 18.63 | 17.76 | 18.57 |
| MgO | 3.34 | 5.92 | 3.80 | 4.39 | 4.36 | 5.62 |
| CaO | 3.25 | 1.08 | 0.04 | 0.04 | 0.89 | 1.10 |
| SnO₂ | 0.05 | 0.05 | 0.05 | 0.05 | 0.05 | 0.06 |
| B₂O₃ | | | | | | |
| TiO₂ | | | | | | |
| K₂O | | | | | | |
| SrO | | | | | | |
| ZnO | | | | | | |
| Minor constituents | 0.05 | 0.07 | 0.04 | 0.04 | 0.04 | 0.05 |
| SUM | 100 | 100 | 100 | 100 | 100 | 100 |
| R₂O/Al₂O₃ | 1.07 | 1.08 | 1.03 | 1.11 | 1.10 | 1.13 |
| Al₂O₃ + MgO | 22.27 | 24.60 | 23.29 | 23.71 | 22.91 | 24.47 |
| R₂O | 20.23 | 20.22 | 20.17 | 21.39 | 20.32 | 21.33 |
| Density (g/cm³) | 2.518 | 2.5 | 2.481 | 2.49 | 2.509 | 2.513 |
| BBV Strain Pt. (° C.) | 589.8 | 601.7 | 609.8 | 603.4 | 590.2 | 581.7 |
| BBV Anneal Pt. (° C.) | 636.2 | 648.1 | 657.6 | 650.4 | 636.9 | 627 |
| Stress Optical Coefficient | 2.694 | 2.743 | 2.763 | 2.7 | 2.692 | 2.74 |
| (nm/mm/MPa) | | | | | | |
| Refractive Index | 1.5232 | 1.5188 | 1.5169 | 1.5172 | 1.5218 | 1.5204 |
| Young's modulus (GPa) | 79.842 | 79.212 | 78.594 | 79.78 | 80.713 | 80.502 |
| Poisson's ratio | 0.227 | 0.222 | 0.215 | 0.213 | 0.226 | 0.225 |
| Fulchers A | −3.057 | −3.196 | −3.325 | −2.934 | −3.106 | −2.807 |
| Fulchers B | 7204.3 | 7365.3 | 7780.4 | 6947.7 | 7188.3 | 6558.1 |
| Fulchers Tₒ | 177 | 180.4 | 168.9 | 203.8 | 175.5 | 205.3 |
| 100 Poise Temperature (° C.) | 1602 | 1598 | 1630 | 1612 | 1583 | 1570 |
| 1000 Poise Temperature (° C.) | 1366 | 1369 | 1399 | 1375 | 1353 | 1335 |
| Liquidus Temperature (° C.) | 1250 | 1225 | 1260 | 1250 | 1225 | 1240 |
| Liquidus Viscosity (kP) | 4.54 | 7.16 | 6.39 | 5.09 | 5.54 | 3.40 |

| Analyzed (mol %) | 13 | 14 | 15 | 16 | 17 | 18 |
|---|---|---|---|---|---|---|
| SiO₂ | 54.75 | 53.39 | 55.76 | 53.46 | 52.72 | 56.43 |
| Al₂O₃ | 18.76 | 19.46 | 19.29 | 19.55 | 19.86 | 18.97 |
| Li₂O | 2.23 | 2.21 | 2.04 | 2.42 | 2.66 | 2.15 |
| Na₂O | 18.66 | 18.39 | 18.38 | 18.44 | 18.48 | 17.53 |
| MgO | 5.46 | 6.39 | 4.25 | 5.84 | 5.94 | 4.21 |
| CaO | 0.05 | 0.06 | 0.04 | 0.04 | 0.06 | 0.04 |
| SnO₂ | 0.05 | 0.05 | 0.15 | 0.15 | 0.15 | 0.06 |
| B₂O₃ | | | | | | 0.48 |
| TiO₂ | | | 0.09 | 0.09 | 0.13 | 0.09 |
| K₂O | | | | | | |
| SrO | | | | | | |
| ZnO | | | | | | |
| Minor constituents | 0.04 | 0.05 | | | | 0.07 |
| SUM | 100 | 100 | 100 | 100 | 100 | 100 |
| R₂O/Al₂O₃ | 1.11 | 1.06 | 1.06 | 1.07 | 1.06 | 1.04 |
| Al₂O₃ + MgO | 24.22 | 25.85 | 23.54 | 25.40 | 25.79 | 23.17 |
| R₂O | 20.89 | 20.60 | 20.42 | 20.86 | 21.14 | 19.68 |
| Density (g/cm³) | 2.499 | 2.507 | 2.492 | 2.505 | 2.508 | 2.481 |
| BBV Strain Pt. (° C.) | 606.7 | 608.5 | | | | |
| BBV Anneal Pt. (° C.) | 652.7 | 655.2 | | | | |
| Stress Optical Coefficient | 2.796 | 2.7 | 2.802 | | | |
| (nm/mm/MPa) | | | | | | |
| Refractive Index | 1.5171 | 1.5188 | 1.5159 | | | |
| Young's modulus (GPa) | 78.763 | 79.79 | 78.20 | | | |
| Poisson's ratio | 0.221 | 0.223 | 0.218 | | | |
| Fulchers A | −2.489 | −2.955 | −3.13 | −2.608 | | |
| Fulchers B | 6022 | 6835.6 | 7334.4 | 6028.3 | | |
| Fulchers Tₒ | 274 | 223.1 | 202.1 | 262.4 | | |
| 100 Poise Temperature (° C.) | 1616 | 1603 | 1632 | 1571 | | |
| 1000 Poise Temperature (° C.) | 1371 | 1371 | 1399 | 1337 | | |
| Liquidus Temperature (° C.) | 1255 | 1280 | | | | |
| Liquidus Viscosity (kP) | 4.46 | 3.26 | | | | |

| Analyzed (mol %) | 19 | 20 | 21 | 22 | 23 | 24 |
|---|---|---|---|---|---|---|
| SiO₂ | 56.20 | 55.78 | 55.78 | 55.76 | 55.82 | 55.86 |
| Al₂O₃ | 19.17 | 19.28 | 19.27 | 19.27 | 19.22 | 19.25 |
| Li₂O | 2.08 | 2.06 | 2.04 | 2.02 | 1.99 | 2.00 |
| Na₂O | 17.77 | 18.26 | 18.35 | 18.42 | 18.44 | 18.34 |
| MgO | 4.17 | 4.27 | 4.24 | 4.27 | 4.24 | 4.26 |
| CaO | 0.04 | 0.04 | 0.04 | 0.04 | 0.04 | 0.03 |
| SnO₂ | 0.05 | 0.09 | 0.10 | 0.10 | 0.10 | 0.10 |
| B₂O₃ | 0.32 | 0.09 | 0.05 | | | |
| TiO₂ | 0.09 | 0.09 | 0.09 | 0.09 | 0.09 | 0.09 |
| K₂O | | | | | | |
| SrO | | | | | | |
| ZnO | | | | | | |
| Minor constituents | 0.12 | 0.05 | 0.05 | 0.04 | 0.06 | 0.06 |
| SUM | 100 | 100 | 100 | 100 | 100 | 100 |
| R₂O/Al₂O₃ | 1.04 | 1.05 | 1.06 | 1.06 | 1.06 | 1.06 |
| Al₂O₃ + MgO | 23.34 | 23.55 | 23.51 | 23.53 | 23.46 | 23.51 |
| R₂O | 19.85 | 20.31 | 20.39 | 20.44 | 20.43 | 20.34 |
| Density (g/cm³) | 2.483 | 2.488 | 2.489 | 2.489 | 2.49 | 2.489 |
| FE Strain Pt. (° C.) | 610 | | 611 | 605 | | 606 |
| FE Anneal Pt. (° C.) | 656 | | 658 | 656 | | 656 |
| Stress Optical Coefficient | | | | | | |
| (nm/mm/MPa) | | | | | | |
| Refractive Index | | | | | | |
| Young's modulus (GPa) | | | | | | |
| Poisson's ratio | | | | | | |
| Fulchers A | | | | | | |
| Fulchers B | | | | | | |
| Fulchers Tₒ | | | | | | |
| 100 Poise Temperature (° C.) | | | | | | |
| 1000 Poise Temperature (° C.) | | | | | | |
| Liquidus Temperature (° C.) | | | | | | |
| Liquidus Viscosity (kP) | | | | | | |
| CTE ×10⁻⁷ (ppm/° C.) | 91.3 | | | | | |
| Analyzed (mol %) | 25 | 26 | 27 | 28 | 29 | 30 |
| SiO₂ | 55.84 | 55.86 | 55.60 | 55.62 | 55.68 | 55.77 |
| Al₂O₃ | 19.27 | 19.27 | 19.31 | 19.31 | 19.28 | 19.23 |
| Li₂O | 2.00 | 2.02 | 2.05 | 2.05 | 2.03 | 2.05 |
| Na₂O | 18.33 | 18.34 | 18.43 | 18.44 | 18.41 | 18.36 |
| MgO | 4.29 | 4.24 | 4.31 | 4.28 | 4.29 | 4.29 |
| CaO | 0.03 | 0.04 | 0.03 | 0.03 | 0.03 | 0.03 |
| SnO₂ | 0.10 | 0.10 | 0.15 | 0.15 | 0.15 | 0.15 |
| B₂O₃ | | | | | | |
| TiO₂ | 0.09 | 0.09 | 0.09 | 0.09 | 0.09 | 0.09 |
| K₂O | | | | | | |
| SrO | | | | | | |
| ZnO | | | | | | |
| Minor constituents | 0.05 | 0.04 | 0.03 | 0.03 | 0.03 | 0.04 |
| SUM | 100 | 100 | 100 | 100 | 100 | 100 |
| R₂O/Al₂O₃ | 1.05 | 1.06 | 1.06 | 1.06 | 1.06 | 1.06 |
| Al₂O₃ + MgO | 23.56 | 23.51 | 23.62 | 23.59 | 23.57 | 23.51 |
| R₂O | 20.33 | 20.37 | 20.48 | 20.49 | 20.44 | 20.41 |
| Density (g/cm³) | 2.489 | 2.489 | 2.492 | 2.491 | 2.491 | 2.491 |
| FE Strain Pt. (° C.) | | 605 | 605 | | 605 | |
| FE Anneal Pt. (° C.) | | 655 | 656 | | 656 | |
| Stress Optical Coefficient | | | | | | |
| (nm/mm/MPa) | | | | | | |
| Refractive Index | | | | | | |
| Young's modulus (GPa) | | | | | | |
| Poisson's ratio | | | | | | |
| Fulchers A | | | | | | |
| Fulchers B | | | | | | |
| Fulchers Tₒ | | | | | | |
| 100 Poise Temperature (° C.) | | | | | | |
| 1000 Poise Temperature (° C.) | | | | | | |
| Liquidus Temperature (° C.) | | | | | | |
| Liquidus Viscosity (kP) | | | | | | |
| CTE ×10⁻⁷ (ppm/° C.) | | | | | 92.9 | |
| Analyzed (mol %) | 31 | 32 | 33 | 34 | 35 | 36 |
| SiO₂ | 55.16 | 53.43 | 53.20 | 53.14 | 53.06 | 53.03 |
| Al₂O₃ | 19.34 | 19.55 | 19.48 | 19.52 | 19.63 | 19.62 |
| Li₂O | 2.09 | 2.42 | 2.66 | 2.66 | 2.67 | 2.67 |
| Na₂O | 18.49 | 18.44 | 18.39 | 18.46 | 18.39 | 18.42 |
| MgO | 4.61 | 5.84 | 5.94 | 5.88 | 5.92 | 5.93 |
| CaO | 0.04 | 0.04 | 0.04 | 0.05 | 0.05 | 0.05 |
| SnO₂ | 0.15 | 0.15 | 0.15 | 0.15 | 0.15 | 0.15 |
| B₂O₃ | | | | | | |
| TiO₂ | 0.09 | 0.09 | 0.09 | 0.09 | 0.09 | 0.10 |
| K₂O | | | | | | |
| SrO | | | | | | |
| ZnO | | | | | | |
| Minor constituents | 0.03 | 0.04 | 0.04 | 0.05 | 0.04 | 0.04 |
| SUM | 100 | 100 | 100 | 100 | 100 | 100 |
| R₂O/Al₂O₃ | 1.06 | 1.07 | 1.08 | 1.08 | 1.07 | 1.07 |
| Al₂O₃ + MgO | 23.95 | 25.39 | 25.42 | 25.41 | 25.55 | 25.55 |
| R₂O | 20.58 | 20.86 | 21.06 | 21.12 | 21.06 | 21.08 |
| Density (g/cm³) | 2.494 | 2.505 | 2.506 | 2.506 | 2.506 | 2.505 |
| FE Strain Pt. (° C.) | 602 | | | | | |
| FE Anneal Pt. (° C.) | 652 | | | | | |
| Stress Optical Coefficient | | | | | | |
| (nm/mm/MPa) | | | | | | |
| Refractive Index | | | | | | |
| Young's modulus (GPa) | | | | | | |
| Poisson's ratio | | | | | | |
| Fulchers A | | | | | | |
| Fulchers B | | | | | | |
| Fulchers Tₒ | | | | | | |
| 100 Poise Temperature (° C.) | | | | | | |
| 1000 Poise Temperature (° C.) | | | | | | |
| Liquidus Temperature (° C.) | | | | | | |
| Liquidus Viscosity (kP) | | | | | | |

| Analyzed (mol %) | 37 | 38 | 39 | A |
|---|---|---|---|---|
| SiO₂ | 53.34 | 55.17 | 53.61 | 59.19 |
| Al₂O₃ | 19.15 | 18.94 | 18.46 | 18.66 |
| Li₂O | 2.63 | 3.05 | 3.02 | 5.78 |
| Na₂O | 18.01 | 18.52 | 18.51 | 11.73 |
| MgO | 5.93 | 4.22 | 5.48 | 1.88 |
| CaO | 0.06 | 0.04 | 0.85 | 1.74 |
| SnO₂ | 0.15 | 0.05 | 0.05 | 0.11 |
| B₂O₃ | | | | |
| TiO₂ | 0.08 | | | 0.05 |
| K₂O | 0.36 | | | |
| SrO | 0.27 | | | |
| ZnO | | | | 0.83 |
| Minor constituents | 0.04 | 0.01 | 0.02 | 0.03 |
| SUM | 100 | 100 | 100 | 100 |
| R₂O/Al₂O₃ | 1.10 | 1.14 | 1.17 | 0.94 |
| Al₂O₃ + MgO | 25.07 | 23.16 | 23.94 | 20.54 |
| R₂O | 20.99 | 21.99 | 21.53 | 17.51 |
| Density (g/cm³) | 2.508 | | | 2.478 |
| BBV Strain Pt. (° C.) | | | | 589.1 |
| BBV Anneal Pt. (° C.) | | | | 634.8 |
| Stress Optical Coefficient | | | | 2.809 |
| (nm/mm/MPa) | | | | |
| Refractive Index | | | | 1.5205 |
| Young's modulus (GPa) | | | | 82.08 |
| Poisson's ratio | | | | 0.215 |
| Fulchers A | | | | −3.226 |
| Fulchers B | | | | 7736.6 |
| Fulchers Tₒ | | | | 138.8 |
| 100 Poise Temperature (° C.) | | | | 1619 |
| 1000 Poise Temperature (° C.) | | | | 1381 |
| Liquidus Temperature (° C.) | | | | 1265 |
| Liquidus Viscosity (kP) | | | | 4.4 |

Example 2: This example demonstrates ion exchanging glass-based substrates to prepare glass-based articles, as well as the resulting properties of the glass-based articles.

Certain glass compositions from Table 1 of Example 1 were formed into glass-based substrates having various thicknesses using conventional glass forming techniques (the “Comp.” in Table 2 indicates the glass composition used from Table 1, and “Exp.” indicates an experiment number). The glass-based substrates were then ion-exchanged in molten salt baths to form glass-based articles. The KNO₃ and K₂C03 were first melted completely in a weight ratio (KNO₃:K₂C03) of 95:5 or 100:0, followed by addition of silicic acid (SA) in an amount of 0.5 wt. %, thereby arriving at the wt. % values set forth in Table 2. The experimental details and resulting properties are reported in Table 2 below. The maximum central tension (CT) and the depth of compression (DOC) were measured with the refractive near field (RNF) technique known in the art, and the maximum compressive stress (CS) and potassium depth of layer (DOL) were measured with a surface stress meter, such as the commercially available FSM-6000 surface stress meter, manufactured by Orihara Industrial Co., Ltd. (Japan), which relies on accurate measurement of the stress optical coefficient (SOC).

TABLE 2

| | | Thick- | | | silicic | | |
|---|---|---|---|---|---|---|---|
| | | ness | KNO₃ | K₂CO₃ | acid | Temp. | Time |
| Exp. # | Comp. | (mm) | (wt. %) | (wt. %) | (wt. %) | (° C.) | (hr) |
| 1 | A | 0.8 | 94.5 | 5 | 0.5 | 410 | 25 |
| 2 | A | 0.8 | 94.5 | 5 | 0.5 | 410 | 10 |
| 3 | A | 0.8 | 94.5 | 5 | 0.5 | 380 | 25 |
| 4 | 1 | 0.8 | 99.5 | 0 | 0.5 | 410 | 4 |
| 5 | 2 | 0.8 | 94.5 | 5 | 0.5 | 410 | 10 |
| 6 | 2 | 0.8 | 94.5 | 5 | 0.5 | 410 | 8.75 |
| 7 | 2 | 0.8 | 94.5 | 5 | 0.5 | 380 | 25 |
| 8 | 3 | 1.0 | 94.5 | 5 | 0.5 | 410 | 7.5 |
| 9 | 4 | 1.1 | 94.5 | 5 | 0.5 | 410 | 7.5 |
| 10 | 4 | 1.0 | 94.5 | 5 | 0.5 | 410 | 6.5 |
| 11 | 4 | 1.0 | 94.5 | 5 | 0.5 | 380 | 16 |
| 12 | 5 | 1.0 | 94.5 | 5 | 0.5 | 410 | 7.5 |
| 13 | 6 | 1.1 | 94.5 | 5 | 0.5 | 410 | 7.5 |
| 14 | 7 | 1.1 | 94.5 | 5 | 0.5 | 410 | 7.5 |
| 15 | 8 | 1.1 | 94.5 | 5 | 0.5 | 410 | 7.5 |
| 16 | 8 | 1.1 | 94.5 | 5 | 0.5 | 410 | 10 |
| 17 | 8 | 1.1 | 94.5 | 5 | 0.5 | 380 | 25 |
| †18 | 15 | 0.8 | 94.5 | 5 | 0.5 | 410 | 3 |
| †19 | 15 | 0.8 | 94.5 | 5 | 0.5 | 410 | 5 |
| †20 | 16 | 0.8 | 94.5 | 5 | 0.5 | 410 | 3 |
| †21 | 16 | 0.8 | 94.5 | 5 | 0.5 | 410 | 5 |
| 22 | 38 | 0.6 | 94.5 | 5 | 0.5 | 410 | 3.25 |
| 23 | 38 | 0.6 | 94.5 | 5 | 0.5 | 410 | 5 |
| 24 | 38 | 0.6 | 94.5 | 5 | 0.5 | 410 | 4 |
| 25 | 38 | 0.7 | 94.5 | 5 | 0.5 | 410 | 4 |
| 26 | 38 | 0.7 | 94.5 | 5 | 0.5 | 410 | 5 |
| 27 | 38 | 0.8 | 94.5 | 5 | 0.5 | 410 | 3.25 |
| 28 | 38 | 0.8 | 94.5 | 5 | 0.5 | 410 | 5 |
| 29 | 39 | 0.8 | 94.5 | 5 | 0.5 | 410 | 7.5 |
| 30 | 39 | 0.6 | 94.5 | 5 | 0.5 | 410 | 6.5 |

| | | CS | DOL | CT | DOC | |
|---|---|---|---|---|---|---|
| Exp. # | Comp. # | (MPa) | (μm) | (MPa) | (μm) | Frangibility |
| 1 | A | 1361.7 | 32.2 | | | N |
| 2 | A | 1391.1 | 18.5 | | | N |
| 3 | A | 1572.6 | 18.1 | | | N |
| 4 | 1 | 1422.0 | 19.0 | | | N |
| 5 | 2 | 1539.7 | 32.5 | 55.8 | 30.5 | Y |
| 6 | 2 | 1523.7 | 30.9 | 52.9 | | Y |
| 7 | 2 | 1577.4 | 32.8 | | | Y |
| 8 | 3 | 1563.5 | 27.5 | 36.5 | | N |
| 9 | 4 | 1605.9 | 30.5 | 43.0 | | slightly |
| 10 | 4 | 1645.9 | 29.2 | 38.9 | 30.1 | N |
| 11 | 4 | 1665.2 | 30.0 | 40.6 | 30.6 | N |
| 12 | 5 | 1618.3 | 21.4 | 29.1 | | N |
| 13 | 6 | 1628.3 | 20.9 | 29.5 | | N |
| 14 | 7 | 1600.0 | 21.7 | 29.3 | | N |
| 15 | 8 | 1633.9 | 25.2 | 35.7 | | N |
| 16 | 8 | 1612.1 | 27.9 | 36.1 | 26.5 | N |
| 17 | 8 | 1636.8 | 26.2 | 35.0 | 24.9 | N |
| †18 | 15 | 1705 | 19.3 | 33.93 | 18.4 | N |
| †19 | 15 | 1685 | 23.7 | 43.17 | 23.2 | N |
| †20 | 16 | 1674 | 14.8 | 28.81 | 15.2 | N |
| †21 | 16 | 1642 | 18.7 | 37.87 | 18.74 | N |
| 22 | 38 | 1757.4 | 17.9 | 45.1 | 17.0 | N |
| 23 | 38 | 1727.9 | 22.1 | | | Y |
| 24 | 38 | 1745.3 | 20.0 | | | Y |
| 25 | 38 | 1757.8 | 19.5 | | | N |
| 26 | 38 | 1735.3 | 22.2 | | | N |
| 27 | 38 | 1757.8 | 18.0 | 34.4 | 17.3 | N |
| 28 | 38 | 1743.9 | 21.6 | 40.2 | 21.0 | N |
| 29 | 39 | 1747.4 | 21.2 | | | N |
| 30 | 39 | 1756.1 | 19.4 | | | N |

†= formed using Lehr annealing in a Lehr conveyor furnace for an annealing cycle of about 2 hours, giving a different thermal history from all the other glasses in the table, which were annealed overnight in standard annealing ovens

Example 3: This example demonstrates a net compressive stress calculated for a glass-based article in accordance with the disclosure as compared to that calculated for a comparative glass-based article.

The glass-based article prepared and analyzed in Experiment 1 from Table 2 in Example 2 was employed in this example as a comparative glass-based article, and the glass-based article prepared an analyzed in Experiment 15 from Table 2 in Example 2 (except assuming a thickness of 0.8 mm) was employed in this example as a glass-based article of this disclosure. The glass-based substrate that was ion-exchanged in Experiment 1 had a Young's modulus of 82.6 GPa, and the glass-based substrate that was ion-exchanged in Experiment 15 had a Young's modulus of 79.2 GPa (see Table 1).

Using Equation 1 and Equation 2 disclosed elsewhere herein, as well as a thickness of 0.8 mm and a radius of curvature of 24 mm, the bend-induced stresses at various depths were calculated. A radius of curvature of 24 mm was selected, as this gave a bend-induced stress of 1377 MPa for the glass-based article of Experiment 1, which is a stress value similar to what was experienced by glass-based articles in product testing (e.g., for use in virtual reality goggles). For compressive stresses, for simplicity, the ion-exchange stress profile was treated as linear, which is a reasonable estimation based on measurement data.

The results are depicted in FIG. 3 and FIG. 4 for the glass-based articles from Experiment 1 (comparative example, CS=1362 MPa, DOL=32 microns, Young's modulus=82.6 GPa, 0.8 mm thick, R=24 mm) and Experiment 15 (glass-based article of the disclosure, CS=1634 MPa, DOL=25 microns, Young's modulus=79.2 GPa, assume 0.8 mm thick, R=24 mm), respectively. As shown in FIG. 3, for the comparative example, the superposition of stresses results in tensile stresses even at the surface. As shown in FIG. 4, for the example of this disclosure, the superposition of stresses results in a residual compressive stress layer extending to a depth of 5 microns in the bent state. The advantages of Experiment 15 over Experiment 1 are apparent from the examples shown in FIG. 3 and FIG. 4. For the fixed bend radius of 24 microns, the bend induced stress is lower for Experiment 15 (stress max is 1377 MPa for Experiment 1 compared to 1320 MPa for Experiment 15). Couple this with a higher IOX compressive stress that extends to a reasonable depth and a compressive layer in the bent state is obtained that extends to a 5 micron depth. Any flaw within this depth cannot extend since flaws only propagate under tension. Other glass compositions expected to have similar benefits to that employed in Experiment 15 are disclosed in Table 1.

Example 4: This example demonstrates a higher hardness for a glass-based article in accordance with the disclosure as compared to that calculated for a comparative glass-based article.

Composition 4 from Table 1 in Example 1 was formed into a glass-based substrate having a thicknesses of 0.8 mm using conventional glass forming techniques. The glass-based substrate was then ion-exchanged in a molten salt bath as described below to form a glass-based article (“Experiment 31” in Table 3). The KNO₃ and K₂C03 were first melted completely in a weight ratio (KNO₃:K₂CO₃) of 95:5, followed by addition of silicic acid (SA) in an amount of 0.5 wt. %, to arrive at an ion exchange bath having 94.5 wt. % KNO₃, 5.0 wt. % K₂C03, and 0.5 wt. % silicic acid. The glass-based substrates were ion-exchanged at 410° C. for 5 hours. The ion-exchange conditions for Exp. 32 and 33 are provided in Table 3, below. The KNO₃ and NaNO₃ were first melted completely in a weight ratio (KNO₃:NaNO₃) of 90:10, 100:0, 30:70, or 95:5, followed by the addition of silicic acid (SA) in an amount of 0.5 wt. %, thereby arriving at the wt. % values set forth in Table 2.

Composition A from Table 1 in Example 1 was formed into a glass-based substrate having a thickness of 0.8 mm using conventional glass forming techniques. The glass-based substrate was then ion-exchanged in molten salt baths as shown in Table 3, below, and employed in this example as comparative examples.

The experimental details and resulting properties are reported in Table 4 below. The maximum central tension (CT) and the depth of compression (DOC) were measured with the refractive near field (RNF) technique known in the art, and the maximum compressive stress (CS) and potassium depth of layer (DOL) were measured with a surface stress meter, such as the commercially available FSM-6000 surface stress meter, manufactured by Orihara Industrial Co., Ltd. (Japan), which relies on accurate measurement of the stress optical coefficient (SOC).

TABLE 3

| | | | | | Silicic | | |
|---|---|---|---|---|---|---|---|
| | | KNO₃ | NaNO₃ | K₂CO₃ | Acid | Temp. | Time |
| Exp. # | Comp. # | (wt. %) | (wt. %) | (wt. %) | (wt. %) | (° C.) | (hr) |
| 31 | 4 | 94.5 | | 5 | 0.5 | 410 | 5 |
| 32 | A | 89.5 | 10 | | 0.5 | 430 | 9 |
| | | 99.5 | | | 0.5 | 430 | 1 |
| 33 | A | 99.5 | | | 0.5 | 430 | 16 |
| | | 29.5 | 70 | | 0.5 | 430 | 1 |
| | | 94.5 | 5 | | 0.5 | 400 | 5 |

TABLE 4

| | | CS | DOL | CT | DOC | |
|---|---|---|---|---|---|---|
| Exp. # | Comp. # | (MPa) | (μm) | (MPa) | (μm) | Frangibility |
| 31 | 4 | 1645.9 | 29.2 | | | N |
| 32 | A | 1439 | 16.7 | 72.9 | 122 | N |
| 33 | A | 1222.2 | 35.5 | 59.5 | 30.5 | N |

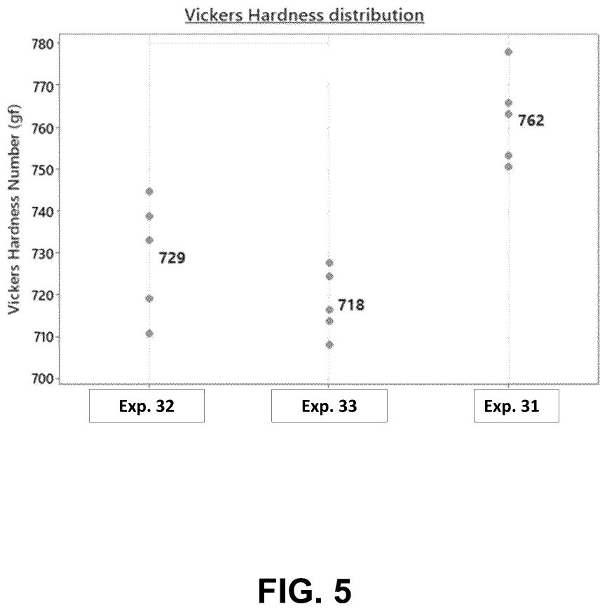

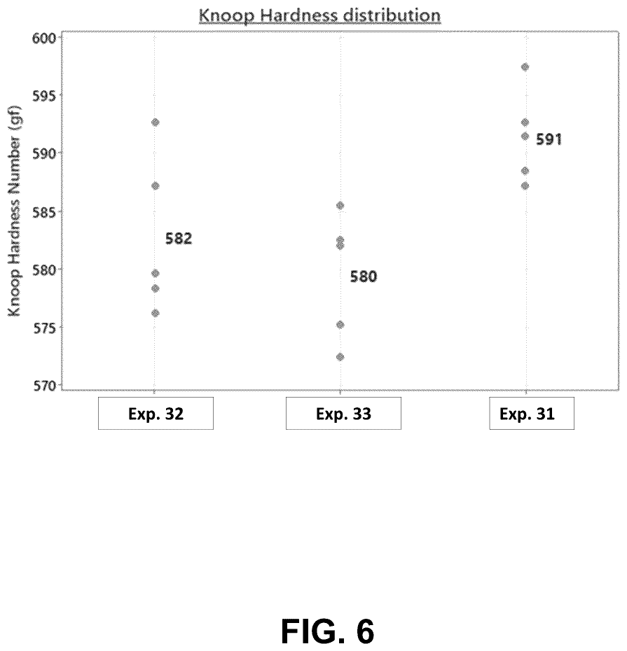

Vickers Hardness and Knoop Hardness distributions were determined. The results are depicted in FIG. 5 and FIG. 6. As shown in FIG. 5, for the example of the disclosure, Exp. 31, the Vickers Hardness distribution was higher than that for the comparative examples, Exp. 32 and 33. As shown in FIG. 6, for the example of the disclosure, Exp. 31, the Knoop Hardness distribution was higher than that for the comparative examples, Exp. 32 and 33. Higher harness makes the glass resistant to damage introduction, thereby improving the glass's retained strength/mechanical performance.

The advantages of Experiment 31 over Experiment 32 and Experiment 33 are apparent from the examples shown in FIG. 5 and FIG. 6. Couple this with a higher IOX compressive stress that extends to a reasonable depth and a more efficient, one-step IOX process. Other glass compositions expected to have similar benefits to that employed in Experiment 31 are disclosed in Table 1.

Example 5: This example demonstrates an improved stress profile and an improvement in retained strength in flaw depths for a glass-based article in accordance with the disclosure as compared to that calculated for a comparative glass-based article.

The glass-based article prepared in Example 4 (Experiment 31) was employed in this example as a glass-based article of this disclosure. The glass-based articles prepared in Example 4 (Experiments 32 and 33) were employed in this example as comparative examples. Glass-based articles with 2 μm HF flare were also prepared.

Pneumatic abrasion was used to impart damage to the glass-based articles. Masking tape with ⅛ inch (about 3.2 mm) diameter hole at the center was used to cover the glass-based articles before abrasion. Thus, the abraded region is restricted to a ⅛ inch circular spot at the center of the sample. 90 grit SiC was used as the abrasive material. Various pressures ranging from 1 PSI to 15 PSI (about 0.007 MPa to about 0.103 MPa) were used to create flaws of varied depths. Abraded samples are tested after 12 hours in 23° C. 50% relative humidity (RH) conditions using Ring-on-Ring (ROR) (Equi-biaxial) flexure. Glass articles with and without 2 μm HF Flare were tested.

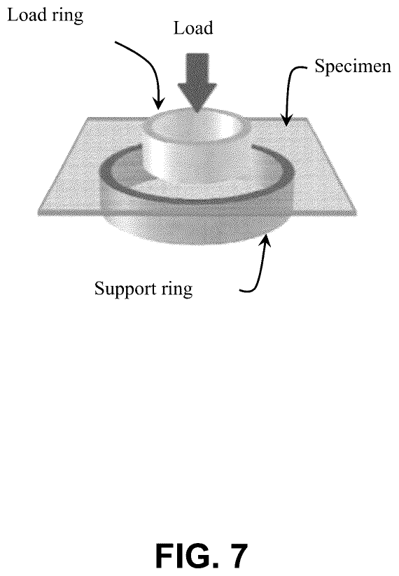

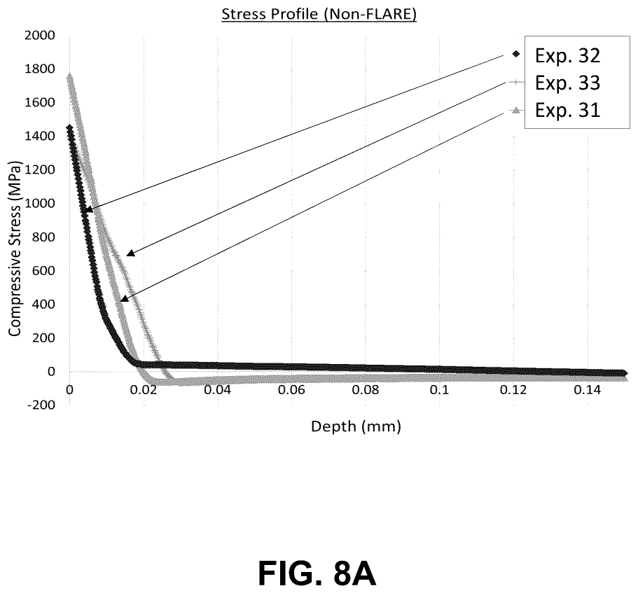

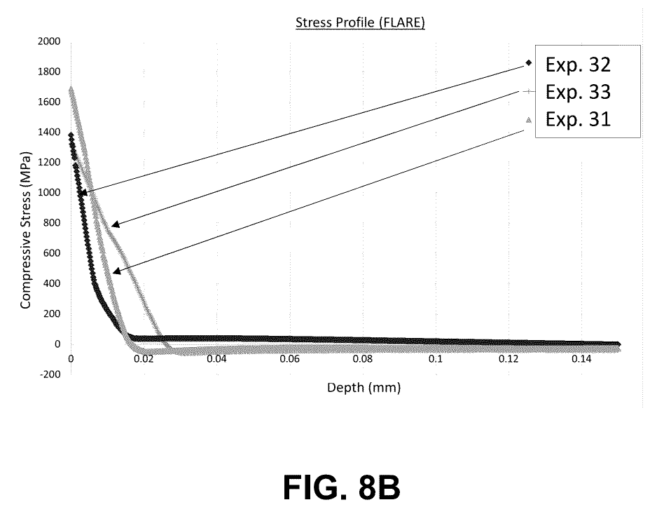

ROR was performed according to ASTM C1499-19 using a 0.5 inch load ring and a 1 inch support ring, as shown in FIG. 7. For quasi-static modes, the strain rate was 0.003/s and the displacement rate was 1.2 mm/min. FIG. 8A and FIG. 8B show plots of compressive strength versus depth for glass-based articles without and with flare, respectively. As can be seen from FIGS. 8A and 8B, the compressive strength was higher for the glass-based articles of the disclosure, Exp. 31, relative to the comparative examples, Exp. 33.

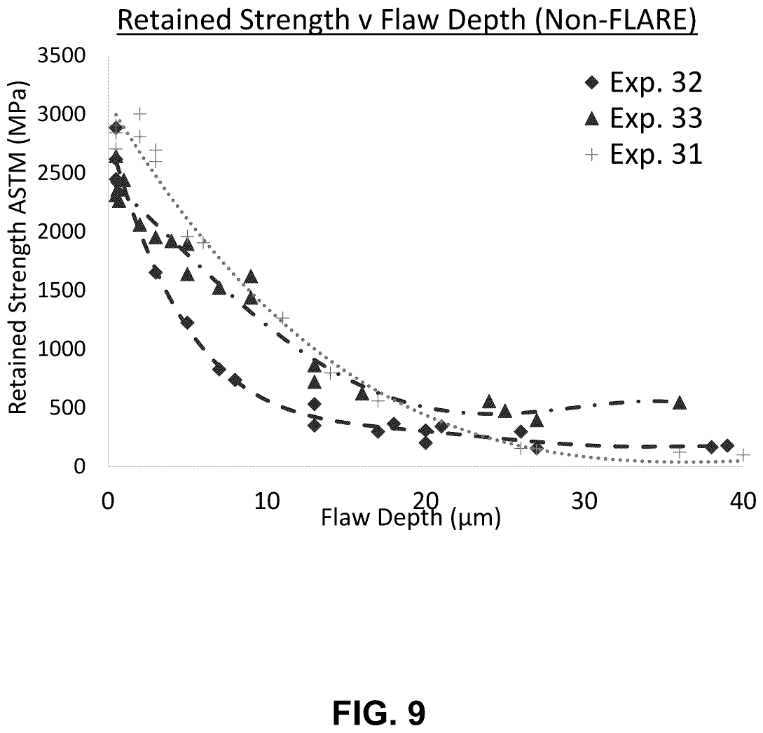

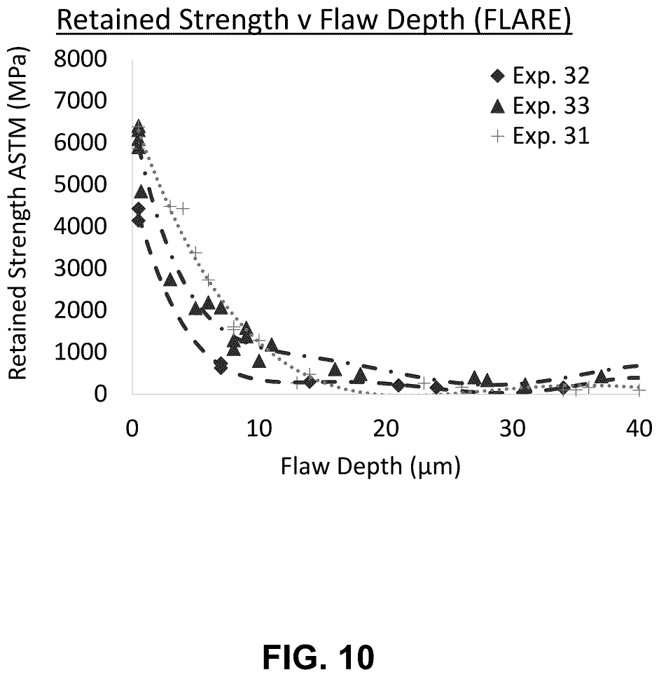

The retained strength was evaluated from the measured failure load. The broken samples were preserved and fractography was performed. The origin of the failure was isolated and flaw depth was measured. The retained strength vs flaw depth was plotted and is shown in FIG. 9 and FIG. 10 for non-flared and flared glass articles, respectively. FIG. 9 and FIG. 10 show that glass-based articles of the disclosure have better retained strength than comparative examples up to about 15 μm for non-flared glass-based articles and about 10 μm for flared glass-based articles.

The advantages of Experiment 31 over Experiment 32 and Experiment 33 are apparent from the examples shown in FIGS. 8-10. Couple this with a higher IOX compressive stress that extends to a reasonable depth and a more efficient, one-step IOX process. Other glass compositions expected to have similar benefits to that employed in Experiment 31 are disclosed in Table 1.

It will be appreciated that the various disclosed aspects or embodiments may involve particular features, elements or steps that are described in connection with that particular aspect or embodiment. It will also be appreciated that a particular feature, element, or step, although described in relation to one particular aspect or embodiment, may be interchanged or combined with alternate aspects or embodiments in various non-illustrated combinations or permutations.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

While various features, elements, or steps of particular aspects or embodiments may be disclosed using the transitional phrase “comprising,” it is to be understood that alternative aspects or embodiments, including those that may be described using the transitional phrases “consisting of” or “consisting essentially of,” are implied. Thus, for example, implied alternative aspects or embodiments to a device that comprises A+B+C include aspects or embodiments where a device consists of A+B+C and aspects or embodiments where a device consists essentially of A+B+C.

References herein to the positions of elements (e.g., “top,” “bottom,” “above,” “below,” “first,” “second,” etc.) are merely used to describe the orientation of various elements in the FIGURES. It should be noted that the orientation of various elements may differ according to other exemplary embodiments, and that such variations are intended to be encompassed by the present disclosure. Moreover, these relational terms are used solely to distinguish one entity or action from another entity or action, without necessarily requiring or implying any actual such relationship or order between such entities or actions.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

As utilized herein, “optional,” “optionally,” or the like are intended to mean that the subsequently described component, event, or circumstance can or cannot occur or be present, and that the description includes instances where the component, event, or circumstance occurs/is present and instances where it does not occur/is not present. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

It will be apparent to those ordinarily skilled in the art that various modifications and variations can be made to the present disclosure without departing from the spirit and scope of the disclosure. Since modifications combinations, sub-combinations, and variations of the disclosed embodiments incorporating the spirit and substance of the disclosure may occur to persons ordinarily skilled in the art, the disclosure should be construed to include everything within the scope of the appended claims and their equivalents.

What is claimed is:

1. A glass composition, comprising:
40-60 mol. % SiO₂;
14-30 mol. % Al₂O₃;
1-10 mol. % Li₂O;
15-30 mol. % Na₂O;
1-20 mol. % MgO;
0-10 mol. % CaO;
0-5 mol. % P₂O₅; and
a Young's modulus of 82 GPa or less.

2. The glass composition of claim 1, comprising 0-1 mol. % P₂O₅.

3. The glass composition of claim 1, comprising TiO₂.

4. The glass composition of claim 1, comprising:
R₂O/Al₂O₃ of 1-1.5, wherein amounts are in mol. %, and R₂O is total amount of Li₂O, Na₂O, K₂O, Rb₂O, and Cs₂O;
R₂O of 19-30 mol. %;
Al₂O₃+MgO of 20-30 mol. %; or
any combination thereof;
wherein amounts are in mol. %, and R₂O is total amount of Li₂O, Na₂O, K₂O, Rb₂O, and Cs₂O.

5. The glass composition of claim 1, comprising:
50-60 mol. % SiO₂;
15-25 mol. % Al₂O₃;
2-5 mol. % Li₂O;
15-25 mol. % Na₂O;
1-10 mol. % MgO;
0-5 mol. % CaO; or
any combination thereof.

6. The glass composition of claim 1, comprising:
0-1 mol. % SnO₂;
0-5 mol. % B₂O₃;
0-2 mol. % K₂O;
0-2 mol. % SrO; or
any combination thereof.

7. A method for ion-exchanging a glass-based substrate, the method comprising:
ion-exchanging the glass-based substrate in a first molten salt bath for a first time period and at a first temperature to form a glass-based article,
wherein the glass-based article comprises:
a compressive stress layer extending from a surface of the glass-based article to a depth of compression,
a potassium layer extending from the surface of the glass-based article to a potassium depth of layer; and
a central tension region, and
the glass-based substrate comprises the glass composition of claim 1.

8. The method of claim 7, wherein the first molten salt bath comprises KNO₃ and optionally K₂CO₃.

9. The method of claim 7, wherein the first time period is 3-12 hours and the first temperature is 340-500° C.

10. The method of claim 7, wherein the potassium depth of layer is 15-50 microns.

11. A glass-based article, comprising:
a compressive stress layer extending from a surface of the glass-based article to a depth of compression;
a potassium layer extending from the surface of the glass-based article to a potassium depth of layer;
a central tension region;
a thickness; and
a glass composition at a center of the glass-based article comprising:
40-60 mol. % SiO₂;
14-30 mol. % Al₂O₃;
1-10 mol. % Li₂O;
15-30 mol. % Na₂O;
1-20 mol. % MgO;
0-10 mol. % CaO; and
0-5 mol. % P₂O₅;
wherein a glass having the same composition and microstructure as the glass composition at the center of the glass-based article has a Young's modulus of 82 GPa or less.

12. The glass-based article of claim 11, wherein the potassium depth of layer is 15-50 microns.

13. The glass-based article of claim 11, wherein the compressive stress layer comprises a maximum compressive stress of 1400-2000 MPa.

14. The glass-based article of claim 11, wherein the glass composition at the center of the glass-based article comprises 0-1 mol. % P₂O₅.

15. The glass-based article of claim 11, wherein the glass composition at the center of the glass-based article comprises TiO₂.

16. The glass-based article of claim 11, wherein the glass composition at the center of the glass-based article comprises:
R₂O/Al₂O₃ of 1-1.5, wherein amounts are in mol. %, and R₂O is total amount of Li₂O, Na₂O, K₂O, Rb₂O, and Cs₂O;
R₂O of 19-30 mol. %;
Al₂O₃+MgO of 20-30 mol. %; or
any combination thereof;
wherein amounts are in mol. %, and R₂O is total amount of Li₂O, Na₂O, K₂O, Rb₂O, and Cs₂O.

17. The glass-based article of claim 11, wherein the glass composition at the center of the glass-based article comprises:
50-60 mol. % SiO₂;
15-25 mol. % Al₂O₃;
2-5 mol. % Li₂O;
15-25 mol. % Na₂O;
1-10 mol. % MgO;
0-5 mol. % CaO; or
any combination thereof.

18. The glass-based article of claim 11, wherein the glass composition at the center of the glass-based article comprises:
0-1 mol. % SnO₂;
0-5 mol. % B₂O₃;
0-2 mol. % K₂O;
0-2 mol. % SrO; or
any combination thereof.

19. Augmented reality headset, comprising:
electrical components comprising a display; and
the glass-based article of claim 11 disposed over the display.

20. A consumer electronic device, comprising:
a housing having a front surface, a back surface and side surfaces;
electrical components provided at least partially within the housing, the electrical components including at least a controller, a memory, and a display, the display being provided at or adjacent to the front surface of the housing; and
a cover substrate disposed over the display;
wherein at least a portion of at least one of the housing and the cover substrate comprises the glass-based article of claim 11.
